(19) United States
(12) Patent Application Publication
(10) Pub. No.: US 2011/0215085 A1
(43) Pub. Date: Sep. 8, 2011

(54) LIQUID HEATING DEVICES

(75) Inventors: Vincent Joseph Garvey, Colby (GB); Colin Moughton, Port St. Mary (GB); Norman Eric Nichol, Santon (GB); Jonathan Michael White, Douglas (GB)

(73) Assignee: STRIX LIMITED, Ronaldsway (GB)

(21) Appl. No.: 13/123,149

(22) PCT Filed: Oct. 7, 2009
(86) PCT No.: PCT/GB2009/002378

§ 371 Date: May 26, 2011

(30) Foreign Application Priority Data
Oct. 7, 2008 (GB) 0818303.0
Dec. 23, 2008 (GB) PCT/GB2008/004252
Jan. 12, 2009 (GB) 0900424.3
Jun. 15, 2009 (GB) 0910321.9

(51) Int. Cl. A47J 31/44; A47J 31/54; A47J 31/56; A47J 31/46

(52) U.S. Cl. 219/440; 219/441

(57) ABSTRACT

An apparatus for heating liquid comprises a heating chamber, a dispensing chamber and a conduit. The conduit conveys heated liquid from the heating chamber to the dispensing chamber for automatic dispensing. The dispensing chamber has valve means through which the heated liquid is dispensed, which are operable to interrupt the automatic dispensing. An apparatus for heating liquid comprises a heating chamber, a dispensing chamber and a conduit. The conduit conveys heated liquid from the heating chamber to the dispensing chamber for automatic dispensing. The apparatus comprises means for determining a volume of heated liquid to be dispensed automatically.

This application is entitled to the benefit of, and incorporates by reference essential subject matter disclosed in PCT Application No. PCT/GB2009/002378 filed on Oct. 7, 2009, which claims priority to Great Britain Application No. 0818303.0 filed Oct. 7, 2008, PCT Application No. PCT/GB2008/004252 filed Dec. 23, 2008, Great Britain Application No. 0900424.3 filed Jan. 12, 2009 and Great Britain Application No. 0910321.9 filed Jun. 15, 2009. This application is also related to U.S. patent application Ser. Nos. 12/810,438 filed Oct. 28, 2010 and 12/810,450 filed Oct. 28, 2010.

### BACKGROUND OF THE INVENTION

1. Technical Field

This invention relates to devices for heating water or other liquids, particularly heating a relatively small volume of liquid in a short space of time.

2. Background Information

There is a common need almost all over the world to heat water in order to make beverages. In the UK and other parts of Europe, it is common for most households to own a kettle which is used to boil water for making occasional beverages. In larger establishments and also in other parts of the world, it is more common to keep a body of water hot or boiling for a prolonged period of time—possibly all day—in order to be able to make such beverages “on demand”, i.e. without having to wait for the water to heat up from room temperature. An example of this would be a traditional electric urn or, more commonly in Asia, a so-called airpot.

Both of these arrangements have their disadvantages. In the case of the kettle, the time taken for the water to heat from cold (i.e. the temperature from which it is drawn from the tap) is seen as inconvenient to users, even those using very high power kettles (of the order of 3 kilowatts). This is particularly so given the difficulty in estimating the volume of water required when the kettle is being filled and the attendant tendency to boil more water than is needed which of course increases the time taken for it to boil. On the other hand, if water is kept for a prolonged period of time either at or just below boiling, a significant amount of energy will be required to counter the unavoidable heat loss.

Recently, devices attempting to bridge this gap have been commercialized. These are said to be able to deliver a cupful of hot water from a reservoir of cold water within a matter of seconds. However, these devices are typically based on a tubular flow heater and the applicant has appreciated some significant drawbacks to this arrangement. Firstly, as is typical of tubular flow heaters, heating must be ceased before the water in the tube reaches boiling point in order to avoid the danger of the heater overheating through hot spots created by pockets of water vapor and/or the pressure inside the tube building up too high. Another drawback is that although the heater heats up relatively quickly, there is inevitably an initial volume of water which passes through the heater which is not heated to the target temperature. This mixes with the water produced later, itself still not at boiling point, to reduce the average temperature of the water. The combination of these two factors means that in practice the water provided by such devices is at well below boiling point by the time it is dispensed, making it unsuitable for example for making tea and thereby limiting its consumer appeal.

The present invention seeks to provide arrangements which allow liquid such as water to be heated, preferably to boiling or near boiling and for a controllable amount of heated liquid to be dispensed.

### SUMMARY OF THE DISCLOSURE

When viewed from a first aspect the present invention provides an apparatus for heating liquid comprising a heating chamber, a dispensing chamber and a conduit for conveying heated liquid from said heating chamber to said dispensing chamber for automatic dispensing therefrom, wherein said dispensing chamber comprises valve means through which said heated liquid is dispensed, said valve means being operable to interrupt said automatic dispensing.

Thus it will be seen by those skilled in the art that in accordance with the invention a device which can supply hot liquids such as water comprises two distinct chambers, for heating and dispensing respectively. The heating chamber is preferably configured to heat a body of liquid, e.g. water, therein to boiling, with the increase in pressure associated with boiling forcing the heated liquid into the conduit and venting it into the dispensing chamber. This means that the dangerous pressurized boiling water and steam are safely ejected into the dispensing chamber whilst the water can be dispensed at the outlet in a slower, more uniform flow which is essentially independent of the water still coming in from the heating chamber. In other words, the dispensing chamber acts effectively to decouple the outlet from the heating chamber from the outlet to the user.

By providing valve means for interrupting the dispensing, a user is given control over how much liquid is dispensed. This further enhances the flexibility and usefulness of such an appliance. The user might exercise control by pre-selecting a time or volume after which the valve should be closed by an automatic mechanism; alternatively and conveniently however, the valve is user-operable so that it can simply be closed by the user in real time when the desired quantity has been dispensed.

There are several possible ways in which the liquid in the dispensing chamber could be dispensed when the valve means is open. For example in one set of embodiments the heated liquid in the dispensing chamber is simply allowed to drain out through a hole communicating with a spout. The dimensions of this hole can be chosen to give a safe maximum outflow rate. In another set of embodiments liquid is dispensed once a certain level has been reached in the chamber—e.g. using a siphon arrangement. In this case the valve might be positioned at the inlet to the siphon to avoid the problem whereby liquid remains in the siphon and cools the next discharge.

Preferably the user-operable valve is coupled to a switch for interrupting or reducing the power to the heater in the heating chamber. For example the valve may be operated by a member configured to act upon a steam-operated switch, although preferably this is a one-way coupling—i.e. operation of the steam switch does not operate the valve.

Such an arrangement could be employed even without a dispensing chamber—i.e. where heated liquid is dispensed directly from the heating chamber. Thus when viewed from a further aspect the invention provides an apparatus for heating a measured amount of liquid, said apparatus comprising a heating chamber having an electric heater for heating liquid therein and a dispensing arrangement for dispensing liquid from said heating chamber, wherein said dispensing arrangement includes a manually operable valve for interrupting dispensing of said liquid wherein said valve is coupled to switch contacts for interrupting or reducing power to the electric heater. As before it is preferred that the switch contacts are associated with a steam-sensitive switch and that the switch is also independently operable to interrupt or reduce power to the electric heater without interrupting dispensing.

Having a valve provided somewhere in the outlet arrangement of the dispensing chamber—e.g. in the dispensing spout—could carry a disadvantage whereby for the next use the liquid retained in the dispensing chamber that had not been dispensed would be dispensed first into the user's receptacle and might, by then, have gone cold, thereby adversely affecting the average temperature of liquid dispensed the next time. However in some preferred embodiments, the dispensing chamber comprises a drainage outlet which allows undispensed liquid to drain from it, e.g. back into the heating chamber or a bulk reservoir. This is novel and inventive in its own right and thus when viewed from another aspect the invention provides an apparatus for heating liquid comprising a heating chamber, a dispensing chamber and a conduit for conveying heated liquid from said heating chamber to said dispensing chamber for automatic dispensing therefrom, wherein said dispensing chamber comprises a drainage outlet for draining liquid that has not been dispensed from the dispensing chamber.

As mentioned above, the drainage outlet could be arranged to drain into the liquid reservoir. However in some embodiments it is arranged to drain into the heating chamber. This is convenient in embodiments where the reservoir is removable since it avoids the need to provide a further separable connection between the reservoir and the rest of the appliance. Thus when viewed from a further aspect the invention provides an apparatus for dispensing heated liquid comprising a heating chamber and a dispensing chamber, the apparatus being configured to eject heated liquid from the heating chamber into the dispensing chamber and from there automatically to dispense said heated liquid, wherein the dispensing chamber comprises a drainage outlet arranged to drain undispensed liquid from the dispensing chamber back to the heating chamber.

Preferably a valve is provided to control the flow of liquid into the heating chamber from the drainage outlet. Typically the valve will be closed while liquid is still being ejected and opened after ejection has finished.

The drainage outlet could be connected to the heating chamber directly by means of a suitable conduit. In a set of preferred embodiments however an auxiliary chamber is provided between the dispensing chamber and the heating chamber which allows the liquid that has drained from the dispensing chamber to collect temporarily, e.g. before the valve admitting the liquid into the heating chamber is opened. This is useful for example where the amount of liquid drained could be greater than the volume of the connecting conduit.

In a set of embodiments the apparatus comprises a removable reservoir. This maximizes the benefits of this arrangement. The reservoir could comprise an independent heating element—i.e. resemble a kettle.

The drainage outlet could be designed with a sufficiently low flow rate that it does not result in a significant amount of liquid draining out in the time-scale of a typical dispensing operation. For example, the drain outlet might be configured to have a flow rate that would drain the entire contents of the dispensing chamber over a period of time which is at least a minute and preferably more than two minutes.

Conveniently the drainage outlet comprises a hole configured to be of suitable size and shape to give a sufficiently low drainage rate but high enough to prevent a meniscus forming over the hole which effectively prevents any drainage.

Alternatively and preferably the drainage outlet comprises a valve. This could be triggered to be opened automatically by a timer or upon some other condition being met. In a set of preferred embodiments the drainage valve is coupled to the valve means controlling the dispensing of liquid from the chamber. This allows the drainage valve to be opened when the dispensing valve is closed and vice versa so that liquid is not retained in the dispensing chamber unnecessarily but equally it does not leak out during dispensing. Accordingly the drainage valve can be configured to allow rapid drainage of any liquid remaining in the dispensing chamber when opened. In convenient embodiments a diverter valve is provided which can direct liquid flow either to a dispense outlet or to a drainage outlet.

In accordance with embodiments of the invention set out above a dispense valve can be arranged either to be operated manually or automatically to determine the volume of water dispensed from the appliance. In many situations the latter arrangement is more convenient for a user as it does not require attention to be paid during dispensing. However it is not essential for a controllable dispense volume to be achieved by means of an automatically-controlled valve through which liquid is dispensed. Thus when viewed from another aspect the invention provides an apparatus for heating liquid comprising a heating chamber, a dispensing chamber and a conduit for conveying heated liquid from said heating chamber to said dispensing chamber for automatic dispensing therefrom, wherein said apparatus comprises means for determining a volume of heated liquid to be dispensed automatically.

In accordance with this aspect of the invention, therefore, a user can pre-set a quantity of heated liquid to be dispensed. In one set of embodiments this is achieved by means for controlling the amount of liquid dispensed from the dispensing chamber; which might be less than the amount heated in the heating chamber. Such means could be arranged to control the amount of liquid passing through the conduit from the heating chamber to the dispensing chamber. For example in one set of embodiments the height of the end of the conduit tube inside the heating chamber is variable to vary the amount of liquid left inside the heating chamber after the heated liquid has been ejected.

In another set of embodiments the apparatus is arranged to control how much of the liquid in the dispensing chamber is actually dispensed. One way of achieving this is by means of an automatically controlled outlet valve as previously mentioned in the context of the first aspect of the invention. However many other ways are possible. For example in some embodiments an outlet siphon arrangement could be provided in which, when the liquid level in the dispensing chamber reaches a predetermined level, a siphon is set up and continues to drain the liquid in the dispensing chamber. To control the amount of liquid dispensed automatically-controlled means, such as a valve, could be provided to disrupt the siphon, e.g. by allowing air into the siphon tube.

In one set of embodiments the dispensing chamber is provided with drainage means for draining some of the liquid rather than dispensing it, said drainage means being adapted so as to give a variable drainage flow rate. Such embodiments can allow convenient control of the amount of liquid dispensed, by suitable setting of the drainage rate relative to the dispensing rate, whilst also being particularly convenient to implement. Although less preferred, an alternative also within the scope of the invention would be to have a fixed drainage rate but have the dispensing rate variable.

Controlling the preset automatic dispense volume and having means for interrupting the dispensing flow are not mutually exclusive and both features could be provided in a given appliance. Thus the volume to be dispensed could be preset, but then over-ridden by a manual stop. In the context of the embodiments described in the preceding paragraph, the drainage means could then perform the additional role of draining the dispensing chamber in the event that dispensing is interrupted.

Additionally or alternatively means might be provided for controlling the amount of liquid actually heated in the heating chamber. Although this might require a greater degree of re-designing of appliances which do not have this feature, it gives the benefit of being more efficient in its use of energy as only the amount of liquid actually required is heated. There are many ways in which this can be achieved. For example a pump or valve regulating the inflow of liquid into the heating chamber, e.g. from a reservoir, could be controlled by a timer or level sensor to deliver a predetermined amount of liquid into the heating chamber. In a set of embodiments the heating chamber is configured so that air is displaced through one or more vents as liquid enters it, the vent(s) being arranged to be closed when a liquid level in the heating chamber corresponding to the predetermined amount has been reached.

This is novel and inventive in its own right and thus when viewed from another aspect the invention provides an apparatus for heating a predetermined amount of liquid comprising: a heating chamber having an outlet for ejecting liquid therefrom under pressure after it has been heated in the chamber, a liquid reservoir; means for transferring liquid from the reservoir to the heating chamber; wherein the heating chamber is configured so that air is displaced through one or more vents as liquid enters it, the vent(s) being arranged to be closed when a liquid level in the heating chamber corresponding to the predetermined amount has been reached.

Conveniently the vent comprises the outlet or conduit through which heated water is ejected from the heating chamber. Mechanical arrangements for closing the vent when the required level is reached can be envisaged, but most conveniently the liquid itself covers the vent to close it.

Preferably the predetermined amount of water can be adjusted by a user. The adjustment could be achieved by adjusting the depth to which the end of the outlet tube or conduit extends into the heating chamber, such as by a telescoping arrangement; or by altering which vent or part of a vent is initially open to allow entry of liquid into the heating chamber: the higher the tube or vent in the heating chamber, the more liquid can enter it.

More generally the invention provides an apparatus for heating a predetermined amount of liquid comprising: a heating chamber having an outlet for ejecting liquid therefrom under pressure after it has been heated in the chamber, a liquid reservoir; means for transferring liquid from the reservoir to the heating chamber; and means for halting the transfer of liquid from the reservoir to the heating chamber when the predetermined amount of liquid has been reached; wherein said means for halting the transfer of liquid is adjustable to vary the predetermined amount of liquid.

The means for halting the transfer of liquid could comprise or act upon the means for transferring liquid. To take one example an adjustable float valve could be employed to regulate the ingress of water into the heating chamber. However, as for the previous aspect of the invention, in a preferred set of embodiments the heating chamber comprises a vent to allow air to be displaced as the chamber fills with liquid, the means for halting the transfer of liquid comprising an arrangement of the vent such that it is closed when the predetermined amount is reached.

In the two foregoing aspects of the invention the outlet is preferably connected to a conduit for conducting liquid to a dispensing chamber for dispensing to a user, e.g. via a spout, as in the previous aspects of the invention.

In some embodiments the inlet to the dispensing chamber is arranged so that any steam which is generated in the heating chamber and passes along the conduit, passes through the water or other liquid which is already held in the dispensing chamber. This has two advantages. Firstly, the steam passing through the water in the dispensing chamber provides additional heat to it as the steam condenses. This helps to raise the bulk temperature of the water in the dispensing chamber, thus countering the negative effect of the first volume of water exiting the heating chamber which may not be at the target temperature.

The second advantage of the arrangement described above is that since steam which exits the heating chamber passes through the water and so condenses, there is a much lower risk of steam being ejected through the ultimate spout of the device and therefore into possible contact with the user. Consequently, the heating chamber can be configured to heat the water to a higher temperature than is possible in a tubular flow heater, i.e. it is more feasible to heat the water to boiling such that steam is produced since the deleterious effects of steam on tubular flow heater arrangements are not a factor to the same extent in arrangements in accordance with embodiments of the invention. The combined effect of these is that in preferred embodiments of the invention, a small amount of liquid, e.g. a cupful, can be delivered to a user virtually at boiling temperature whilst without the risk of steam being ejected along with the water.

Although the dispensing chamber is preferably configured such that steam exiting the inlet arrangement of the dispensing chamber re-condenses, e.g. during its passage through the liquid held in the chamber, it is likely that some steam will pass up into the space above the liquid. It is preferred therefore that the dispensing chamber has one or more ventilation outlets on the upper part thereof to prevent the build-up of pressure above the retained liquid. This has the advantages that enough steam reaches the steam switch and also prevents the dispense rate from being too fast.

In accordance with all aspects of the invention the heating chamber is preferably configured to heat a body of liquid, e.g. water, therein to boiling, with the increase in pressure associated with boiling forcing the heated liquid into the conduit and venting it into the dispensing chamber.

The heater associated with the heating chamber could take any convenient form. It could, for example, comprise an immersion type heater or, preferably, a heater forming a wall of the heating chamber, preferably the base of the heating chamber.

Indeed, in convenient embodiments the heater is substantially similar to that used in ordinary domestic kettles, e.g. with a sheathed resistance heating element bonded to the underside of the heater plate. In alternative embodiments a thick film heater could be employed.

Water or other liquids may be supplied to the heating chamber in any convenient manner, e.g. by means of a pump or hydrostatic pressure. In presently preferred embodiments, however, a liquid reservoir is provided adjacent the heating chamber and is in selective fluid communication therewith. For example the heating chamber could comprise a sub-divided portion of a larger liquid reservoir from which liquid is selectively permitted to pass into the heating chamber when required. The selective communication could, for example, be by means of a wall, divider or baffle which is at least partly retractable, but preferably is provided by a valve in a wall of the chamber. Preferably the heating chamber is below the rest of the reservoir so that water can flow therein under gravity/hydrostatic pressure.

In some embodiments the reservoir is removable—e.g. to permit re-filling.

In one set of embodiments the valve is closed when the heating chamber is filled to the required level. For example the position of said valve might be dependent upon the level of water in the heating chamber. Conveniently the valve is configured to be buoyant to achieve this. In one set of embodiments, a flap valve is provided which is configured so as to be held shut when the heating chamber is filled to the required level. In accordance with another set of embodiments, a freely floating valve member is employed, which is more robust than a flap valve. The valve member might take any convenient form. For example it could comprise a ball. Alternatively it could be pill, discus or squat-cylindrical in shape. In a preferred set of embodiments the valve member is downwardly tapering, e.g. frusto-conical. This has been found to minimize the chance of the valve member sticking during use.

Where provided, the valve controlling entry of liquid that has been drained from the dispensing chamber into the heating chamber also preferably comprises a freely floating valve member, preferably downwardly tapering, e.g. frusto-conical.

In all embodiments where the heating chamber is separated from a reservoir by a valve, the valve is preferably configured such that increasing pressure in the heating chamber tends to force the valve closed. This will of course be the case with the flap valve and valve members discussed above.

The valve could comprise a simple, e.g. circular, orifice in the wall separating the water reservoir and heating chamber. In one set of preferred embodiments however the orifice has a shape comprising a plurality of lobes extending from a central region. This has been found, for a given area of orifice, to provide better flow characteristics by allowing air from the heating chamber to pass into the reservoir through the lobes.

In some preferred embodiments the valve inlet is configured to admit liquid primarily laterally rather than primarily vertically. Also preferred is that one or more baffles is provided around the valve inlet. These measures each help to avoid too much air being drawn into the heating chamber when the level of liquid in the reservoir is low. This reduces noise as the Applicant has discovered that it is the sharp intake of air which gives rise to high noise levels.

Preferably the heating chamber is provided with a pressure relief valve that opens when pressure in the heating chamber exceeds a threshold. This could arise for example if the outlet tube should become blocked for any reason. A conventional pressure relief valve venting to the atmosphere could be provided—e.g. similar to those found on traditional espresso coffee makers. In preferred embodiments however the pressure relief valve is configured to vent excess pressure into an unpressurized part of the interior of the appliance—e.g. the water reservoir where such is provided. This is considered to be safer in essentially eliminating the risk, however unlikely, that steam will be vented, at pressure, near a user. Moreover in a preferred set of embodiments it allows the pressure-relief valve to perform a second function whereby it also acts to admit water into the heating chamber. In other words in some preferred embodiments the valve is configured to open when there is a pressure differential across it in either direction. Preferably it is configured to open at a lower pressure differential in one direction than the other. This allows it to function as described above more effectively since the vacuum set up in the heating chamber at the end of the heating cycle will typically represent a lower pressure differential to atmospheric than the over-pressure at which pressure relief is required.

In a preferred set of arrangements the valve described above comprises a domed resilient diaphragm having at least one slit defined therein. The domed shape gives the asymmetric pressure characteristics mentioned above. As the pressure on the concave side of the diaphragm becomes increasingly greater than on the convex side, e.g. because a vacuum is created on the convex side, the slit in the diaphragm is forced open, thereby allowing fluid communication through it. This functioning makes it suitable for admitting water into the heating chamber when a vacuum is formed therein after it has been emptied of boiling water. In preferred embodiments therefore the valve is between the water reservoir and heating chamber with the concave side of the diaphragm facing the water reservoir. The valve described here could replace the flap valve or floating valve member arrangements described above. Preferably however it is provided in addition thereto. This helps to reduce the unwanted noise associated with a rapid suction of water into the heating chamber as it increases the overall effective area through which the water is sucked.

Should pressure in the heating chamber approach a dangerous level at any stage, the pressure on the convex side will become sufficient to reverse the curvature of the diaphragm in a ‘snap’ action which causes the slit to open and so allow a reduction in pressure in the heating chamber.

So far arrangements have been described in which the heating chamber is refilled automatically after dispensing takes place, by one or more valves responsive to a drop in liquid level and/or a drop in pressure in the heating chamber. However these are not the only possibilities. In another set of embodiments a valve is provided which is responsive to steam generated by water in the heating chamber boiling. There are of course many ways of achieving this—e.g. electronically, but in a simple example a steam-sensitive actuator (such as a bimetallic actuator) is mechanically coupled to a valve between the reservoir and the heating chamber. This is preferably arranged so as to close the valve upon actuation of the actuator in the presence of steam to prevent cold water entering the heating chamber until the next heating cycle is selected by a user. In such arrangements the apparatus is preferably arranged to refill the heating chamber when the next heating operation begins.

Since in preferred embodiments boiling liquid is forced under pressure into the conduit and into the dispensing chamber, the dispensing chamber could be provided at any convenient disposition relative to the heating chamber, e.g. to the side of it or below it, but preferably the dispensing chamber is above the heating chamber. In a preferred set of embodiments, the heating chamber and dispensing chamber are provided respectively in the lower and upper parts of a vessel, with the vessel defining a water reservoir therebetween.

The heating chamber could be sealed, apart from the conduit to the dispensing chamber. In a set of preferred embodiments however ventilation means are provided to the heating chamber. There are several potential benefits to this. One potential benefit is that the ventilation could reduce the build-up of pressure in the heating chamber during the initial stages of heating to prevent water being ejected from the conduit before it has been sufficiently heated. Another benefit is to vent away steam which can destabilize the valve member during the heating phase thus letting in cold water which would increase the boil time. Another potential benefit is that it can act to prevent a dangerous build-up of pressure in the heating chamber in the event that the outlet conduit becomes blocked for any reason. This might be in addition to or instead of a pressure relief valve, e.g. of the type discussed hereinabove.

The ventilation means could communicate with the water reservoir, e.g. it could simply comprise one or more apertures between the water reservoir and the heating chamber. In a preferred set of embodiments the ventilation means is open to air. This is beneficial in avoiding a potential source of noise when pressurized air and steam passes through the water reservoir. It can also help in the smooth admission of water into the heating chamber from the reservoir by allowing the displaced air to escape.

The ventilation means could be arranged to vent to the exterior of the appliance but this is not considered ideal as it raises the possibility of steam being ejected near to a user. Preferably therefore it is vented to an airspace within the appliance. This could be a specially-designed space, or the reservoir. Preferably though the ventilation means is arranged to vent to the dispensing chamber. The ventilation means preferably vents from the upper part of the heating chamber, most preferably from the upper surface thereof—i.e. it vents from the ‘headspace’ created when the heating chamber is filled with water, to try to ensure that gases rather than liquids are ejected from it.

Typically the dimensions of the ventilation means will be chosen so that when water in the chamber is first heated the pressure build-up therein is insufficient to eject it into the dispensing chamber, but as the water approaches boiling, sufficient pressure is developed in the heating chamber to eject the water.

As mentioned previously, in accordance with preferred embodiments the liquid in the heating chamber is heated to boiling and thereby forced into the dispensing chamber via the conduit. However, the applicant has recognized that since it is a relatively small volume of water being heated, the thermal inertia of a typical heating element, for example a sheathed element attached to the underside of the base of the heating chamber (a so called “underfloor” heater) can become significant. However, by taking this into account, thermal stress on the element can be reduced by deliberately switching the element off before the liquid in the heating chamber reaches boiling point and relying on the residual heat in the element to bring the liquid to boiling and eject it. This reduces the risk of the element being energized without being in contact with liquid and therefore overheating.

Of course, the temperature at which the element needs to be switched off in order to achieve this effect is dependent on the liquid being heated, its volume and on the thermal mass of the element itself. Using a standard sheathed underfloor element and a heating chamber volume of approximately 200 ml, it has been found that the temperature at which the element needs to be switched off is approximately 90° C. Thus, in accordance with some embodiments of the invention, a control means is provided which is configured to interrupt power to the element when the temperature of the water has reached 90° C. Conveniently, such a control may be provided in the form of a variant of one of the applicant's U series of controls developed for kettles (further details of which are disclosed in WO 95/34187), but with one of the bimetallic actuators being replaced with one having an operating temperature of approximately 90° C. Using such a control advantageously provides a second backup actuator in the event of the element overheating e.g. by being operated with no water in the heating chamber which might be as a result of there being no water in the reservoir.

In an alternative set of embodiments, the apparatus is configured to switch off the heating element in response to detection of another part of the heating-and-dispense cycle. In one set of embodiments the apparatus comprises means for switching off a heating element associated with the heating chamber responsive to the presence of at least one of water, steam, or an elevated temperature or pressure in the dispensing chamber. For example in one embodiment a float-operated switch, which could be variable to provide a variable dispense volume, is provided in association with the dispensing chamber to switch off the element when a predetermined liquid level is reached in the dispensing chamber. In another embodiment a steam-sensitive actuator is used to switch off the element.

In a set of embodiments, a conventional steam switch is provided in gaseous communication with the heating chamber such that steam produced therein impinges on the steam switch. In one set of embodiments the steam switch is provided at the top of a vertical tube, the neck of said tube being narrower than the conduit and/or the tube otherwise being configured to prevent the heated water from being forced into it as boiling point is reached. The steam switch is, in some embodiments, arranged to close a valve between the reservoir and the heating chamber. Additionally or alternatively it is acted upon by a manually operated dispensing-interrupt mechanism to switch off the heater.

In any of the embodiments set out above the mechanism for switching off the element could be configured such that there is enough pressure for all or substantially all of the liquid being heated in the heating chamber to be ejected. However in accordance with some embodiments envisaged the configuration of the heating chamber and element switching-off mechanism could be such as deliberately to leave some liquid remaining in the heating chamber. This could be beneficial in reducing the “thermal shock” suffered by the element and/or heating chamber when fresh, colder liquid is added, e.g. from a reservoir. It is also beneficial in reducing the amount of steam generated after the bulk of the liquid has been ejected (and so minimizing the reset time of a bimetallic actuator if provided). It also reduces the risk of sufficient steam being produced at the beginning of the heating part of the cycle to terminate the cycle prematurely. For example, the Applicant has found that by making the conduit tube referred to above shorter, some liquid is left in the heating chamber at the end of the cycle. As previously discussed, this amount could be variable—e.g. by raising or lowering the end of the conduit tube within the heating chamber. In a set of preferred embodiments however the heater is adapted to retain liquid preferentially in one or more parts thereof, e.g. in a heated region. For example where the heater comprises a sheathed heating element attached to the underside of a heating plate, the plate can be formed with a depression above some or all of the element. This minimizes the volume left behind (and so the energy wasted in each heating cycle) but ensures that the water is where it is most needed.

### BRIEF DESCRIPTION OF THE DRAWINGS

Certain preferred embodiments of the invention will now be described, by way of example only, with reference to the accompanying drawings in which:

FIG. 1 is a cutaway view of an appliance which can be modified in accordance with the invention and which is described for reference purposes only;

FIGS. 2 and 3 are cross-sections through the heating chamber of the appliance of FIG. 1;

FIG. 4 is a cross-section through the dispensing chamber and outlet spout of the appliance of FIG. 1;

FIG. 5 is a view similar to FIG. 4 of the dispensing chamber of another appliance described for reference purposes only;

FIG. 6 is a cross-section through a heating chamber;

FIG. 7 is a sectional view through a heating chamber and steam tube;

FIG. 8 is a sectional view through a different dispensing chamber;

FIG. 9 is a sectional view through yet another dispensing chamber;

FIG. 10 is a perspective view of a heating chamber upper wall member showing two separate valve arrangements:

FIG. 11 is a sectioned view from beneath of the wall member of FIG. 10;

FIG. 12 is a schematic representation of an embodiment of the invention;

FIG. 13 is a schematic representation of a mechanism for varying the amount of water heated;

FIG. 14 is a schematic view of part of the mechanism of FIG. 13;

FIG. 15 is a view of certain components of an embodiment of the invention with the outlet conduit sectioned;

FIG. 16 is a sectional view through the components shown in FIG. 15;

FIG. 17 is a sectional view through the dispensing chamber of a further embodiment of the invention;

FIG. 18 is an exploded view of some of the components shown in FIG. 17;

FIGS. 19a and 19b are sectional views of the dispensing chamber of another embodiment of the invention with the valve thereof in different respective positions;

FIG. 20 is a perspective external view of the dispensing chamber of a yet further embodiment of the invention;

FIGS. 21 and 22 are perspective sectional views of the dispensing chamber of FIG. 20 with the valve thereof in different respective positions.

FIG. 23 is a perspective view of some components of a further embodiment of the invention employing a removable reservoir; and

FIG. 24 is a section through the components of FIG. 23.

### DETAILED DESCRIPTION OF THE INVENTION

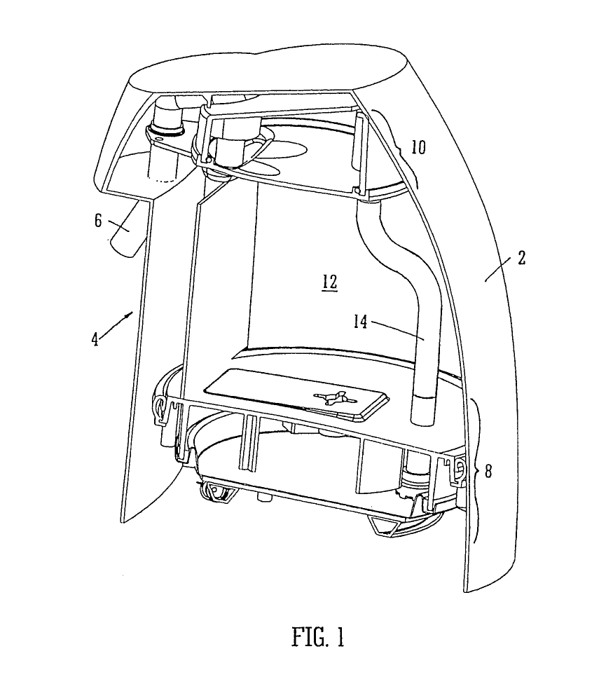

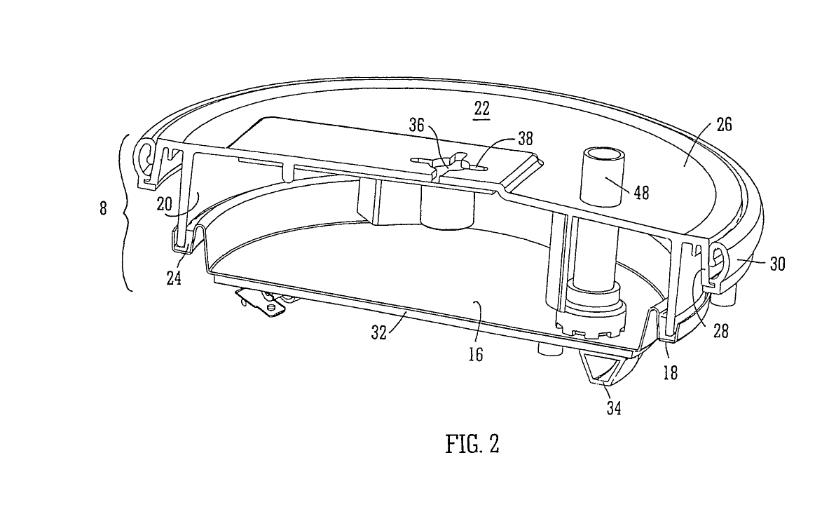

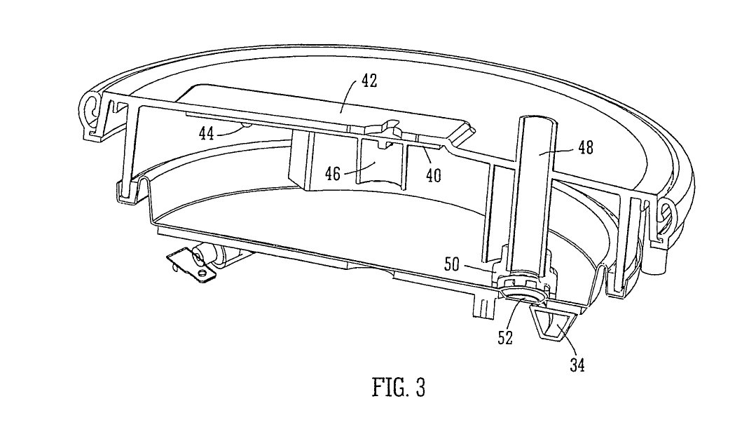

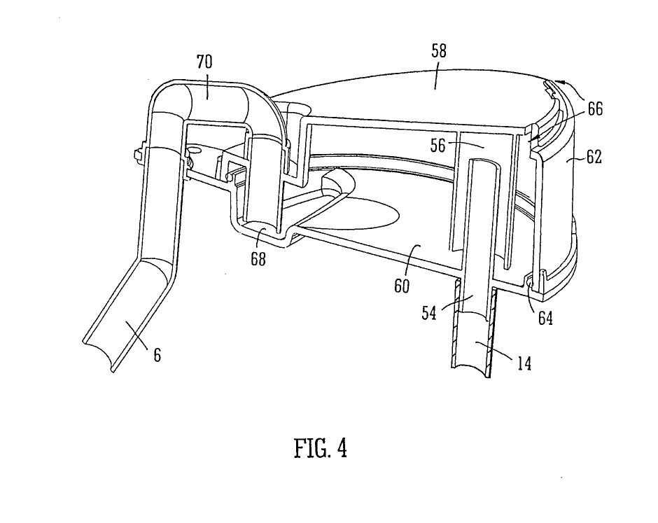

Turning firstly to FIG. 1 there is shown a hot water dispensing vessel which has an outer body 2 with a front “undercut” portion 4 defining a space that permits a user to place a cup or other receptacle under an outlet spout 6. Inside, the vessel is divided into three main parts. In the lower part of the vessel is a heating chamber 10 which will be described in greater detail below with reference to FIGS. 2 and 3. At the upper part of the vessel is a dispensing chamber 10 which will be described in greater detail below with reference to FIG. 4. Between the heating chamber 8 and the dispensing chamber 10 is a water reservoir section 12. This can be filled using a suitable opening in the body (not shown). A conduit tube 14 passes through the water reservoir 12 and connects the heating chamber 8 to the dispensing chamber 10.

Turning now to FIGS. 2 and 3, the heating chamber 8 may be seen in more detail. The base of the heating chamber is defined by an underfloor heating element arrangement as is well-known to those skilled in the art of kettles and other water boilers. It thus comprises a metallic, preferably stainless steel plate 16 which has a generally planar central portion but is formed at its periphery with an upwardly open channel 18 which receives a downwardly depending wall portion 20 of heating chamber cover member 22. Also in the channel 18 is an L-section seal and, as is well-known in the art and described in greater detail in WO 96/18331, the walls of the peripheral channel 18 can in use be clamped together to form a secure and watertight seal between the heating plate 16 and the downwardly depending wall portion 20.

The aforementioned annular wall portion 20 depends downwardly from an approximately planar upper portion 26 of the heating chamber cover member 22. Radially outwardly of the aforementioned annular wall 20 is a further downwardly depending annular wall 28 at the periphery of the cover member 22. A seal 30 is fitted around the outside of the abovementioned wall 28 and, as may be appreciated by referring back to FIG. 1, the seal 30 serves to seal the chamber member against the main vessel wall 2. The particular type of seal used here is described in greater detail in EP-A-1683451, but the particular form of seal is not essential to the invention.

The heating chamber therefore encloses an approximately disc-shaped volume which might be somewhere in the order of 200 to 500 ml.

On the underside of the metallic plate 16 is a thin aluminum heater diffuser plate to which is brazed an arcuate sheathed electric heating element 34 in a conventional manner A thick film printed element could be used instead.

At the center of the heating chamber cover member 22 is a water inlet orifice 36. As will be appreciated from FIG. 1, the chamber wall member 22 forms a dividing barrier between the water reservoir 12 and the heating chamber 8. The orifice 36 can therefore allow water to flow from the water reservoir 12 into the heating chamber. The orifice 36 is formed with four radially extending lobes 38 which give improved flow as compared to a circular aperture of the same overall area. Beneath the orifice 36 is a flap valve 40 (seen best in FIG. 3). The flap valve 40 has an elongate rectangular shape and as can also be seen from FIG. 3, it is received in a rebate 42 defined in the underside of the upper surface 26 of the chamber cover member. The flap valve 40 is made of silicone rubber and is staked to the upper surface of the cover member by a pair of rivets 44. The flap valve 40 is planar for most of its length although at its distal end, directly beneath the orifice, a cylindrical downwardly open cup 46 is integrally molded thereon.

On the right-hand side of FIGS. 2 and 3 is a vertically extending cylindrical tube 48, the upper end of which receives the lower end of the conduit tube 14. The lower end of the vertical tube 48 is received by a foot member 50 which is castellated around its lower edge in order to allow the passage of water and steam between the castellations whilst acting as a coarse filter against the ingress of e.g. large pieces of scale etc. Directly beneath the vertical tube 48 the heater plate 16 is formed with a shallow recess 52 which facilitates the flow of water up into the tube 48 as it undergoes the required 90° change of direction. The tube 48 can conveniently be molded into a suitably formed aperture in the upper surface 26 of the chamber cover member. The arrangement shown seeks to maximize the amount of water ejected from the heating chamber. However it might be desirable for some water to remain in the heating chamber—e.g. to protect the element against the thermal shock of the sudden ingress of cold water. This can be achieved by making the tube 48 shorter so that it stops short of the heater plate 16, or by making the castellations larger.

The upper dispensing chamber 10 will now be described with reference to FIG. 4. Protruding from beneath the chamber is an inlet pipe 54 which receives the upper end of the conduit 14. As may be seen, the inlet pipe 54 extends vertically inside the chamber to about three quarters the maximum height of the chamber. The inlet pipe 54 extends up into a larger diameter, coaxial, cylindrical tube 56 which depends downwardly from the top of the chamber 58. The downwardly depending tube 56 extends down just short of the base of the chamber 60.

It will be seen that the chamber comprises two parts: an upper part providing the sloping top of the chamber 58 and correspondingly tapering side wall 62; and the lower part forming the base of the chamber 60. These two parts are snap-fitted or screwed together with an O-ring seal 64 being provided between them. Around the upper part of the side wall 62 where it meets the highest part of the sloping top 58, a series of apertures 66 is provided in a slightly recessed part of the wall 62 which in use allow any steam at the top of the chamber to escape into the main vessel body.

On the opposite side of the chamber to the inlet arrangement 54, 56, the base of the chamber 60 is stepped down to form a shallow sump 68. Although not visible a small hole is provided at the bottom of the sump. Immediately above this sump and spaced a few millimeters from the base of it, is one, downwardly open, end of the outlet tube 70. As can be seen, the outlet tube extends initially vertically up from the sump 68, then horizontally for a short distance and then vertically down before terminating in an angled spout 6. It may also be seen that the top of the chamber 58 drops down around where the outlet tube 70 emerges from it in order more easily to accommodate the bends associated with its shape.

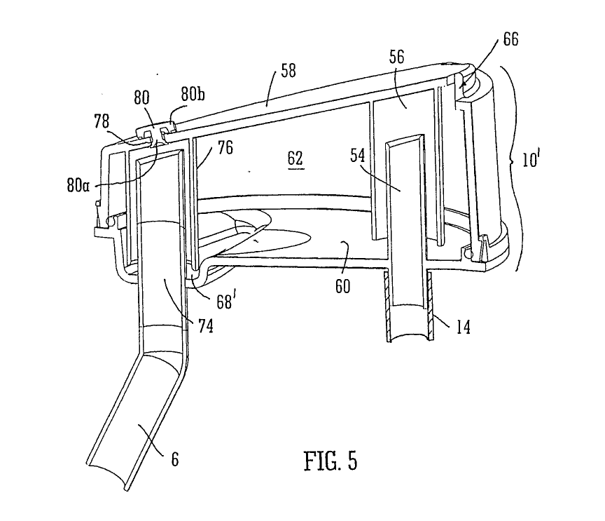

FIG. 5 shows a variant of the dispensing chamber 10′. This differs from the arrangement described above with reference to FIG. 4 in the configuration of the outlet tube. Here, the outlet tube 74 extends up through the bottom of the recessed sump area 68′ inside a larger diameter, coaxial cylindrical tube 76 depending downwardly from the top of the chamber 58, so that the outlet of the chamber has a similar configuration to the inlet. The inner one of the coaxial tubes 74 extends to just a few millimeters short of the top of the chamber 58, whilst the outer tube 76 extends just short of the base of the sump area 68′. An aperture 78 is formed in the top of the chamber 58 on the common axis of the two outlet tubes 74, 76. This is normally closed by a resiliently deformable plug 80. This is formed with an annular skirt at the base of its stem 80a which extends slightly proud of the inwardly facing edge of the aperture 78 and is normally retained in this position by an annular peripheral ring 80b on the underside of the enlarged head portion of the valve which bears against the upper surface of the top of the chamber 58. However, if pressure is applied to the head of the plug 80, it deforms so as to rotate the rim 80b upwardly and away from the outer surface of the upper chamber wall 58 and simultaneously projects the stem portion 80a through the aperture thereby bringing the base of the stem away from the edge of the aperture 78: The result of this is that the seal provided by the plug 80 in the aperture 78 is broken, thereby allowing air past it and into the outlet tubes 74, 76.

A description of the operation of the appliances described above will now be given, with reference to FIGS. 1 to 5.

Initially, the vessel 2 is filled with water, thereby filling the reservoir 12. If the heating chamber 8 is empty, the pressure of the water in the reservoir will cause water to open the flap valve 40 and therefore fill the heating chamber 8 through the orifice 36. As the water level in the heating chamber 8 begins to rise, air trapped in the cup 46 at the distal end of the flap valve 40 will cause the flap valve to rotate up to its closed position against the rebate 42. Thus once the chamber 8 has filled to a predetermined level, the valve is closed and no more water flows in.

When it is required to dispense boiling water, the heating element 30 is energized which rapidly heats the relatively small volume of water in the heating chamber. Since the chamber is essentially enclosed, as the water is heated, the pressure in the chamber begins to increase. On one hand this serves to provide further closure pressure for the flap valve 40 against the recess 42 and thereby counters any tendency for further water to leak into the heating chamber, e.g. as a result of turbulence in the water being heated. On the other hand, the pressure begins to force water up the outlet tube 48 and into the conduit 14.

As the temperature of the water in the heating chamber 8 reaches approximately 90° C., a bimetallic actuator on the control unit (not shown) reaches its operating temperature and reverses its curvature in a snap action in order to open a set of electrical contacts and thereby interrupt the supply of electrical power to the heating element 34. However, although the element 34 is then de-energized, its finite (and known) thermal mass means that heat is stored in it which continues to be dissipated even after it has been de-energized. This heat is sufficient to bring the relatively small volume of water in the chamber 8 to boiling point.

As the water in the chamber 8 reaches boiling point, the pressure in the chamber increases rapidly as steam is produced. This pressure forces the boiling water up the outlet tube 48 into the conduit 14 and then into the inlet arrangement 54, 56 of the dispensing chamber 10. Although most of the water in the heating chamber will be at boiling point, there is a small quantity of water that is initially ejected therefrom which is at a slightly lower temperature since it entered the outlet tube 48 before it had been heated to boiling.

As will be appreciated from FIG. 4, as the pressurized, boiling water is forced up the conduit 14 into the inlet pipe 54 it will impinge upon the roof of the chamber 58 inside the larger diameter tube 56. The water will then pass down the outer inlet tube 56 around the smaller inlet tube 54 and exit through the gap between the base of the chamber 60 and the lower end of the tube 56. As the dispensing chamber 10 begins to fill up therefore, the boiling water from the heating chamber will enter the main part of the dispensing chamber 10 at the bottom.

Particularly when the heating chamber 8 is nearly empty, steam is forced up the conduit 14 along with the boiling water. This too will tend to eject against the roof of the dispensing chamber 58 inside the outer cylindrical tube 56, where some will condense, but some steam will pass out underneath the bottom of the tube 56 and into the water held in the dispensing chamber. The effect of this steam exiting into the water and therefore passing through it is to warm the water in the dispensing chamber 10 back to boiling point from which it will have inevitably dropped slightly by virtue of mixing with the cooler water initially ejected. Steam which does not condense during its passage through the water will pass into the space above the water at the top of the chamber from where it may escape through the vents 66 at the highest part of the chamber.

As the water level in the chamber rises, the level of water will similarly rise in the first downwardly extending part of the outlet tube 70. When the water level in the main chamber 10 has risen sufficiently, the water in the outlet tube 70 will reach the horizontal portion and then start to flow out under gravity towards the outlet spout 6. This sets up a siphon so that substantially the whole of the chamber is drained, the recessed sump region 68, ensuring that there is only a tiny volume of water left at the bottom which the siphon cannot drain out. Although the dispensing of the water commences as boiling water is still being ejected from the heating chamber and into the dispensing chamber, the configuration of the inlet to the dispensing chamber 10—in this arrangement the double coaxial tubes forming a “water trap”—means that the dangerous pressurized boiling water and steam are safely ejected into the dispensing chamber 10 whilst the water being dispensed at the outlet is a slow, uniform flow which is essentially independent of the water still coming in from the heating chamber. In other words, the dispensing chamber acts effectively to decouple the outlet from the heating chamber from the outlet to the user.

The base of the dispensing chamber 60 has a gentle slope so that the last of the water in it will collect in the sump region 68 and so be drained out by the outlet tube siphon apart from a very thin layer at the bottom of the sump 68. The amount of water remaining in the sump will typically be of the order of only a few milliliters and thus even when, in the next cycle of operation, the remaining water which would by then have cooled is mixed with the fresh incoming boiled water, it will have a negligible impact on the bulk temperature of the water in the dispensing chamber. However, even this is avoided by the small drain aperture (not shown) at the lowest point of the sump 68 in order to allow the water remaining in the sump to drain slowly out and back into the water reservoir 12. The aperture is chosen to be small enough that a negligible amount of water drained out over the time scale of the dispensing, which is only of the order of tens of seconds.

Thus in the arrangement described above it can be appreciated that in a very short period of time a predetermined quantity of water is heated to boiling and dispensed through a spout in a safe and controlled manner. This can be achieved despite the water being heated fully to boiling point and moreover despite the inevitable mixing with a small quantity of water that did not reach boiling point. The negative effect of such cooler water is ameliorated by passing steam generated at the end of the boiling process through it prior to it being dispensed. The steam condenses and brings the bulk temperature of the water substantially or completely back to boiling point. Thus the water dispensed to the user is at least substantially at boiling point and can therefore be used for any application where boiling water is required e.g. for making tea.

Returning to FIGS. 2 and 3 and the heating chamber 8, this is left at the end of the dispense cycle filled with steam. As the steam begins to cool and condense, the pressure in the heating chamber 8 is rapidly reduced, thus forcing open the flap valve 40 and sucking in cold water from the reservoir 12 to refill the heating chamber 8 ready for the next cycle of operation.

In the arrangements described above, once the siphon has been set up in the outlet tube 70, it will persist until the dispensing chamber 10 has been emptied. Thus the apparatus will always dispense the same, fixed amount of boiling water. However, the modified arrangement shown in FIG. 5, allows for some control of the amount of boiling water dispensed. Here, as the dispensing chamber 10′ fills with water, the water level will rise inside the downwardly depending outlet tube 76 around the periphery of the inner coaxial tube 74. As the water level in the chamber continues to rise so that the water level in the tube 76 reaches the top of the inner coaxial tube 74 a siphon will be set up as the water drains out through the outlet tube 74 to the spout 6. Normally this siphon will drain substantially all of the contents of the dispensing chamber 10′ through the spout 6. However, in this arrangement the user has the option to depress the resilient plug 80, thereby allowing air into the downwardly depending tube 76. This disrupts the siphon and therefore stops further water being drawn out of the dispensing chamber. This therefore provides an effective mechanism for controlling the amount of water dispensed by depressing the button when a desired amount has been reached (noting of course that the water actually in the outlet tube 74 and spout 6 will be dispensed after the valve button 80 is depressed).

The drain aperture in the sump 68′ (again not shown) is particularly advantageous here in order to allow any water remaining in the dispensing chamber 10′ to drain slowly out after dispensing has finished (say over a time of the order of minutes). Without this there would be the possibility, if a user were to interrupt the dispensing early on, for a relatively large volume of water to remain in the dispensing chamber after the end of a dispensing cycle, which could have a negative impact by cooling the water dispensed in the next cycle.

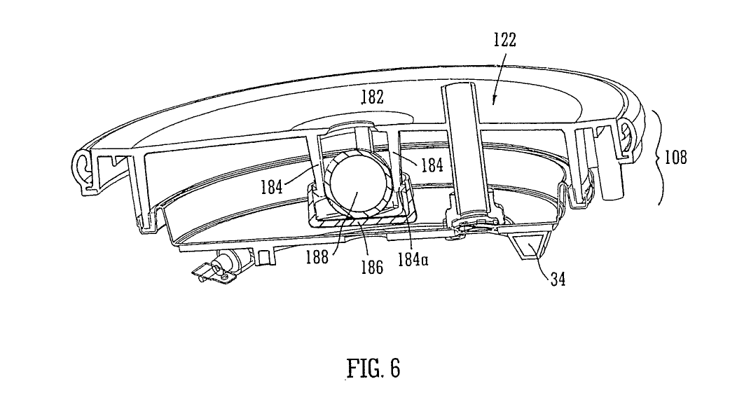

FIG. 6 shows a further appliance in which the heating chamber is modified as compared to the first two appliances described. The difference here is that instead of the previously described flap valve arrangement, there is a ball valve arrangement. The heating chamber cover member 122 has a circular central aperture 182 defined therein, with a series of four integrally molded and circumferentially spaced legs 184 depending downwardly from the lower surface of the chamber cover member 122 surrounding the aperture 182. The distal end of each leg 184 is formed with an outwardly facing hook-like projection 184a. These engage under an undercut in the annular upper rim of a top hat-shaped cage member 186. The cage member 186 can therefore be hooked onto the projections 184a to retain it in place vertically beneath the aperture 182.

The legs 184 and the cage member 186 between them define a cylindrical space in which a hollow, buoyant ball 188 can rise and fall over a short vertical travel. In the lower position depicted in FIG. 6, water can clearly pass through the aperture 182 from the water reservoir into the heating chamber 108. However, when the buoyant ball 188 is held against the underside of the aperture 182, it forms a seal, thereby preventing any further water entering the heating chamber 108. Moreover it will be observed from a careful study of FIG. 6, that when the ball 188 is in the lower position, the clearance between the surface of the ball 188 and the legs 184 is insufficient to allow them to flex inwardly enough to release the cage member 186. The consequence of this is that although the cage member 186 is held by a relatively simple click-fit mechanism, as long as the ball 188 is relatively incompressible, the cage member 186 cannot come away from the legs 184.

In operation the difference provided by this arrangement is that if after dispensing has occurred and the reduction in pressure in the heating chamber 108 causes the rapid and possibly violent sucking in of water from the reservoir, the ball valve arrangement is able to withstand the more violent forces and does not suffer from any risk of becoming stuck in an open position. Again, both pressure within the chamber and the buoyant nature of the hollow ball 188 ensure that it is held closed when the chamber 108 is filled with water and during heating.

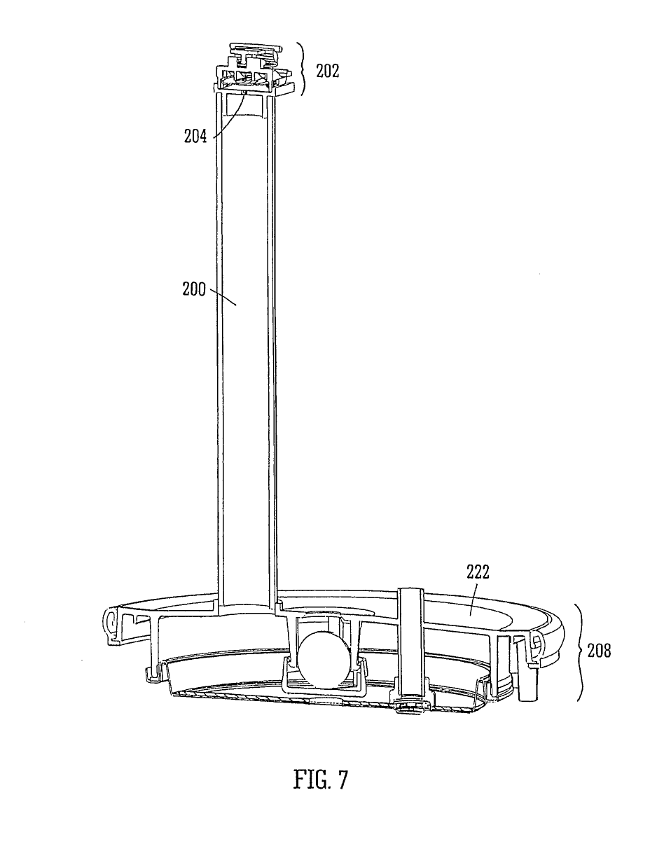

FIG. 7 shows a variant of the arrangement described above with reference to FIG. 6. In this arrangement, it will be noted that there is a relatively wide, vertical, cylindrical riser tube 200 extending from the heating chamber cover member 222 and opening into the heating chamber 208 at its lower end. At the top of the vertical riser tube 200, behind a small aperture, 204 is the applicant's standard R48 steam switch 202 which is more commonly used in domestic kettles for automatically switching them off when boiled. As is well known to those skilled in the art this comprises a snap acting bimetallic actuator which acts on a rocker arm that moves over-center to open a set of electrical contacts.

In this arrangement, the heating element 34 is not de-energized when the water in the heating chamber 208 reaches 90° C., but rather when sufficient steam reaches the bimetal of the steam switch 202. The small aperture 204 provided at the top of the tube can be tuned to give the desired perfoimance. Since the aperture 204 is relatively narrow, even when water in the heating chamber boils, it will not be forced up the tube 200 by the steam pressure. Moreover, since the steam switch 202 is at the top of the steam tube 200, which is the reverse of the conventional arrangement in automatic kettles, it is likely to be actuated when the water is just reaching boiling or even just before, which mimics the action described in respect of the previous arrangement whereby the element is switched off prior to boiling and residual heat in the element is used to bring the water fully to boiling. The advantage of this arrangement over using a bimetal in contact with the diffuser plate to sense the temperature of the water is that it is more tolerant to the build-up of scale on the surface of the heater plate which can raise the running temperature of the heater plate compared to the water temperature. It also enables the use of pre-existing components in the shape of steam switch itself and in the control unit which is still required for protection against dry switch on. A standard U17 control could be used for example.

This arrangement also avoids the need for a relatively tight tolerance bimetal for sensing the temperature of the water at the appropriate point. Otherwise, the operation of this arrangement is identical to those previously described.

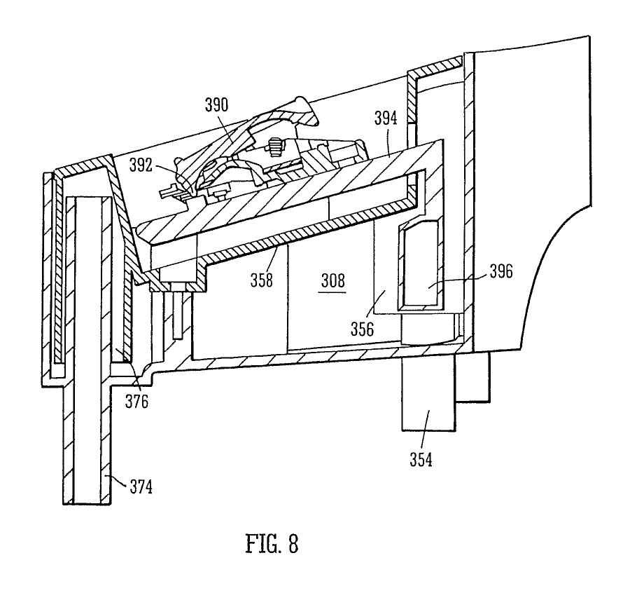

FIG. 8 shows the dispensing chamber of a further appliance. This is a modified version of the dispensing chamber shown in FIG. 5. In common with earlier arrangements it comprises a double tube inlet 354, 356 and double-tube outlet 374, 376 and a drain hole is provided although it is not shown. However this arrangement differs in that the top of the chamber 358 defines a recess which receives a modified version of the Applicant's R48 steam switch 390 with the bimetal removed. This therefore acts simply as a latching, over-centre switch. The ‘nose’ 392 of the over-centre trip lever is acted upon by the end of a pivotally mounted lever 394 rather than a bimetal which would be conventional. At its other end the pivoting lever 394 has a downwardly depending arm, at the lower end of which is an integrally formed hollow float 396.

In use as water begins to near boiling in the heating chamber (not shown) and is ejected into the dispensing chamber 308 via the inlet tubes 354, 356 in the manner previously described, the water level in the heating chamber will begin to rise. This lifts the float 396 and thus causes the arm 394 to rock back and so act on the trip lever 392 and cause it to trip, so switching off power to the heating element of the heating chamber. This method of switching off the heater might be more reliable than using a sensor (e.g. a bimetal) sensing the temperature of the heater plate as this temperature can be affected after some time by the presence of scale build-up inside the heating chamber. It is also less reliant on the tolerance of such a sensor or bimetal.

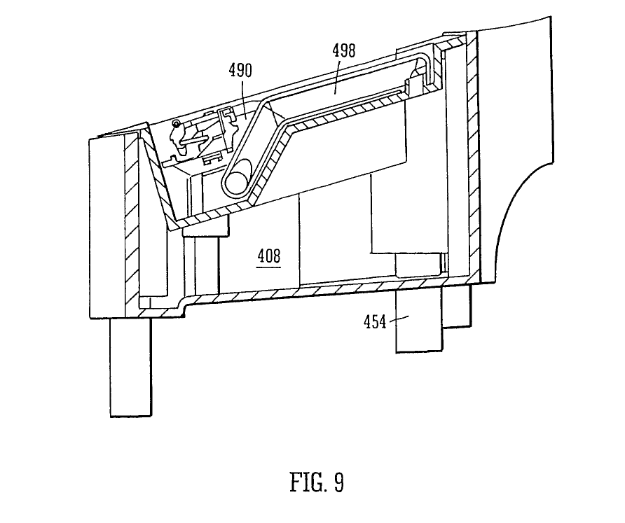

FIG. 9 shows an alternative arrangement. This is similar to that of FIG. 8, except that here the steam switch 490 is fully conventional—i.e. the bimetal is retained—and instead of a float aim, a steam tube 498 communicates the bimetal of the steam switch with the interior of the dispensing chamber 408. In this arrangement therefore the presence of steam in the dispensing chamber is used as the trigger to switch off the heating element. It will be appreciated from the earlier description that there will be relatively little steam that has passed through the water in the chamber 408, however this is balanced by the proximity of the steam switch 490 to the chamber in comparison with FIG. 7 say, or ordinary steam tube and steam switch arrangements.

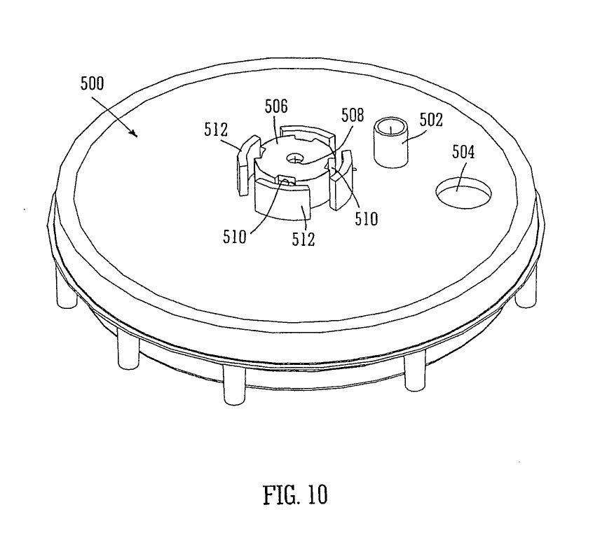

FIG. 10 shows a heating chamber cover member 500 which can be used with embodiments of the invention. It has a vertically projecting tube 502 to connect the heating chamber beneath to the upper dispensing chamber. The cover member 500 also defines an aperture 504 into which a pressure relief valve is fitted.

In the center of the cover member 500 is a hollow, cylindrical projection 506 which has a hole 508 at the top and a series of four vertical slots 510 spaced around its side wall. Corresponding arcuate baffles 512 are provided opposite and spaced slightly from each of the slots 510. The slots 510 cause water to exit the reservoir primarily laterally rather than vertically. The baffles 512 disrupt the flow into the slots. Both of these help to prevent excessive amounts of air being drawn into the heating chamber when the water level in the reservoir is low, which is a significant factor in generating unwanted noise.

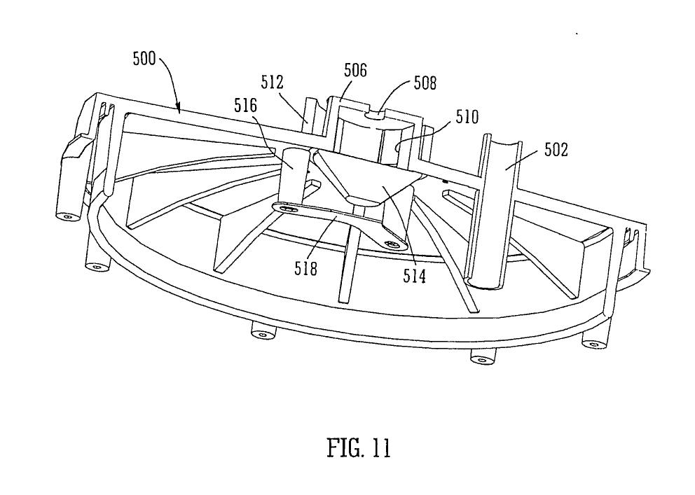

As FIG. 11 shows, the valve arrangement differs from those previously described. Instead of a ball valve, here the valve member 514 is frusto-conical in shape with its taper downward. Rather than a cage, the valve housing is formed by three downwardly protruding bosses 516 (two of which are visible) to which tri-lobed valve stop plate 518 is attached. This valve arrangement has been found to be very robust without the valve member becoming jammed. Of course other shapes of valve members and other housing arrangements could be used.

Returning to the circular aperture 504 in the cover member (see FIG. 10), this is closed in use by a silicone rubber grommet valve which acts both as a pressure relief valve and to admit water into the heating chamber. In other words it can be opened by a pressure differential across it in either direction.

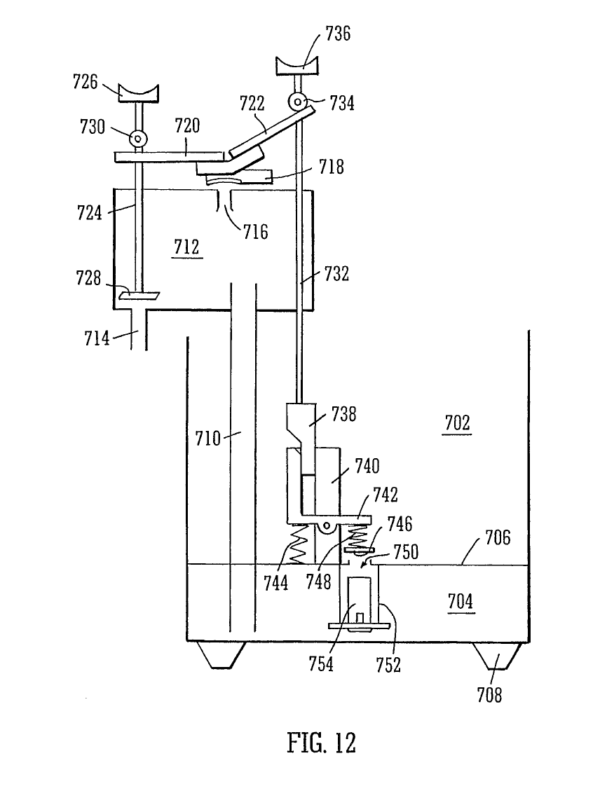

FIG. 12 shows, highly schematically, an embodiment of the invention. As in the appliances described previously, the apparatus comprises a water reservoir 702 which is above a heating chamber 704 which is fowled by a horizontal dividing wall 706 in the lower part of the interior of the vessel. A sheathed electric heating element 708 is provided on the underside of the heating chamber 704 in a manner similar to that previously described.

A vertical conduit tube 710 communicates the interior of the heating chamber 704 with an upper dispensing chamber 712. Although shown highly schematically in the presently-described Figure, the basic configuration of the dispensing chamber 712 may be the same as in any of the previously described arrangements. The dispensing chamber 712 has a dispensing spout 714 from which heated water can be dispensed into a user's cup or other receptacle. In the upper wall of the dispensing chamber 712 is a small aperture 716 against which is mounted the bimetallic actuator of a steam switch 718 such as the applicant's well-known R48 steam switch. The switch contacts of the steam switch 718 are connected in series with the electrical power supply to the heating element 708 so that when the steam switch is activated, the contacts are opened and the power to the heating element 708 is interrupted. Two extension arms 720, 722 are attached to respective sides of the over-centre rocker incorporated in the R48 steam switch 718.

In axial alignment with the dispensing spout 714 is a vertically slidable rod 724 which has a user push knob 726 at its upper end and a valve seal 728 at its lower end. The valve seal 728 is disposed so that when the user push button 726 is depressed, the seal 728 covers over the outlet to the dispensing spout 714. Although not clearly visible in the schematic representation of FIG. 12, the vertical rod described above passes through a forked portion at the distal end of the extension arm 720 attached to the steam switch 718. A lateral protrusion 730 from the rod 724 is disposed to engage the forked portion of the extension arm 720 so that when the user knob 726 is depressed, the protrusion 730 can pivot the rocker of the steam switch unit 718 in an anti-clockwise direction to open the associated switch contacts and switch off the heating element 708.

A similar vertical rod 732 is arranged to pass through the forked distal end portion of the other extension arm 722 so that a corresponding lateral protrusion 734 can act upon the extension arm 722 and rotate the switch in a clockwise direction when the user button 736 is depressed. At the lower end of this latter-mentioned vertical rod 732 is a cam member 738 which has a profile having two substantially parallel portions joined by a sloping portion. The cam member 738 is disposed to slide vertically in a gap between a mounting boss 740 mounted to the dividing wall 706 and the vertical limb of L-shaped crank lever 742 which is pivotally mounted to the mounting boss 740 part-way along its horizontal limb. A compression spring 744 acts to bias the vertical limb of the lever 742 against the cam member 738. A valve seal 746 is mounted on a further compression spring 748 which depends from the distal end of the horizontal limb of the lever 742. The seal 746 is arranged so that when the lever 742 is in its furthest clockwise position (that which is shown in FIG. 12) it is sealingly biased against a valve seat 750 in the horizontal wall 706 which divides the reservoir 702 from the heating chamber 704. It should be noted, however, that the seal 746 is shown spaced away from the valve seat 750 for the purposes of clarity in the schematic FIG. 12.

Immediately beneath the valve seat 750 is a downwardly depending tube 752 in which a buoyant valve member 754 is disposed so that when it is raised by water in the heating chamber 704 it seals against the lower edge of the inlet tube 752.

Operation of the embodiment shown in FIG. 12 will now be described. First the water reservoir 702 is filled with cold water. When the user wishes to boil a measured amount of water, he or she depresses the appropriate user button 736 which moves the rocker of the steam switch 718 clockwise via the lateral protrusion 734 and the extension arm 722 and thereby switches on power to the heating element 708 which therefore begins to heat. At the same time, downward pressure on the push rod 732 causes the cam member 738 to slide downwardly between the mounting boss 740 and the pivoting lever 742 so that the upper vertical edge of the lever 742 engages the sloping face of the cam member 738 which therefore forces the lever 742 to rotate in an anti-clockwise direction against the force of the compression spring 744 in a wedge-like manner. The downward travel of the vertical push rod 732 is such that the cam member 738 is moved down until the upper vertical edge of the lever 742 has traversed across the sloping face of the cam member 738 and is adjacent the other vertical face of the cam member 738. At this point, the vertical limb of the lever 742 can no longer present any vertical resistance force and the resulting arrangement can be considered to be a hair-trigger mechanism.

The anti-clockwise movement of the lever 742 relieves the sealing pressure between the valve seal 746 and the valve seat 750 to allow water to flow into the heating chamber 704 from the reservoir 702. This flow of water continues for a few seconds until the level of water in the heating chamber 704 is sufficient to force the buoyant valve member 754 against the lower edge of the inlet tube 752 to prevent the entry of any further water.

Thereafter, as the water in the heating chamber 704 begins to boil, the boiling water will be forced up the outlet conduit 710 and into the dispensing chamber 712 so that it can pass out of the dispensing spout 714. When nearly all of the water has been ejected from the heating chamber 704, sufficient steam pressure is developed in the dispensing chamber 712 that enough steam passes through the small aperture 716 to impinge on the bimetallic actuator of the steam switch 718 and cause it to actuate, moving the rocker switch anti-clockwise and switching off power to the heating element 708. However, residual heat in the element 708 boils and ejects almost all of the rest of the water remaining in the heating chamber. Preferably this is configured so that a small amount of water remains in the chamber. This is beneficial in reducing the amount of steam generated after the bulk of the water has been ejected (and so minimizing the reset time of the bimetallic actuator). It also reduces the risk of sufficient steam being produced at the beginning of the heating part of the cycle to switch of the heater and close the inlet valve prematurely. Although not shown in the Figures, this could be enhanced by configuring the chamber to ensure that a small amount of water remains—e.g. by forming the heater plate to which the element 708 is attached with a depression above some or all of the heater tube. This minimizes the volume left behind (and so the energy wasted in each heating cycle) but ensures that the water is where it is most needed.

As the steam switch rocker rotates in an anti-clockwise direction, the extension arm 722 acts on the lateral protrusion 734 of the vertical rod 732 to raise it by a small amount (of the order of 1 to 2 mm). This small upward movement is sufficient to move the upper edge of the lever 742 onto the sloping face of the cam member 738, whereafter the force supplied by the compression spring 744 is sufficient to drive the cam member 738 and therefore the rod member 732 upwards back to the position shown in FIG. 12 with the reservoir valve seal 746 once again biased into sealing engagement with its valve seat 750 to prevent the flow of water from the reservoir 702 to the heating chamber 704. The apparatus is therefore once again ready for use in the manner described above.

In the operation described above, a fixed amount of boiling water is automatically dispensed. In some circumstances however, a user may wish to interrupt dispensing of the water—e.g. if the user has forgotten to place a cup underneath the dispensing spout 714 or has placed a cup which is too small. In this situation, he or she can simply press the push button 726 to move the corresponding push rod 724 downwardly and thereby close the valve formed by the circular valve member 728 to close the outlet to the dispensing spout 714. This action also switches off the heating element 708 by means of the lateral protrusion 730 from the push rod 724 acting on the extension arm 720 attached to the rocker of the steam switch 718. It is important to cease heating once the outlet 714 has been closed since the heating chamber 704 and the dispensing chamber 712 then effectively form a sealed system. Optionally one or more drain holes could be provided.

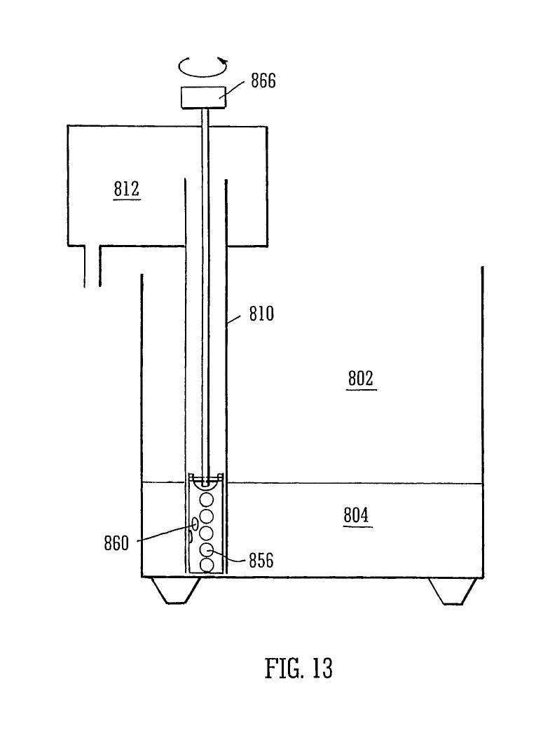

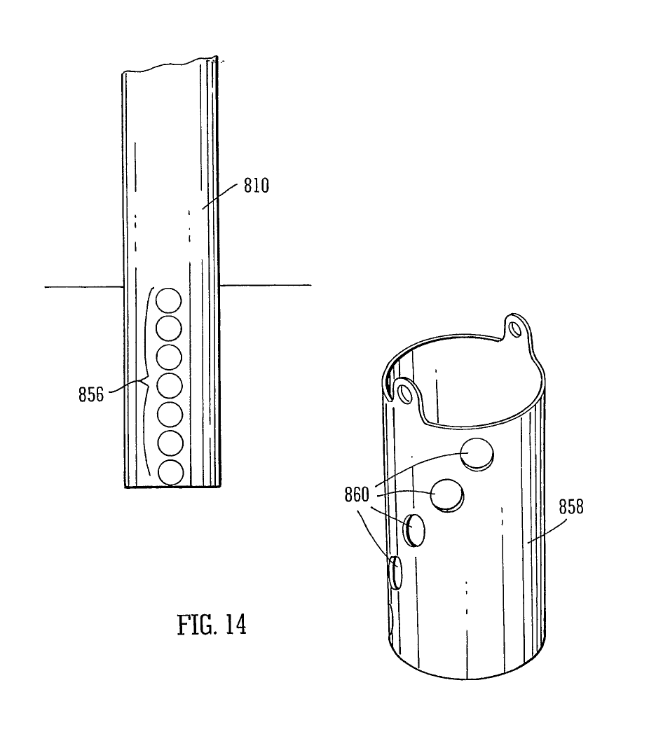

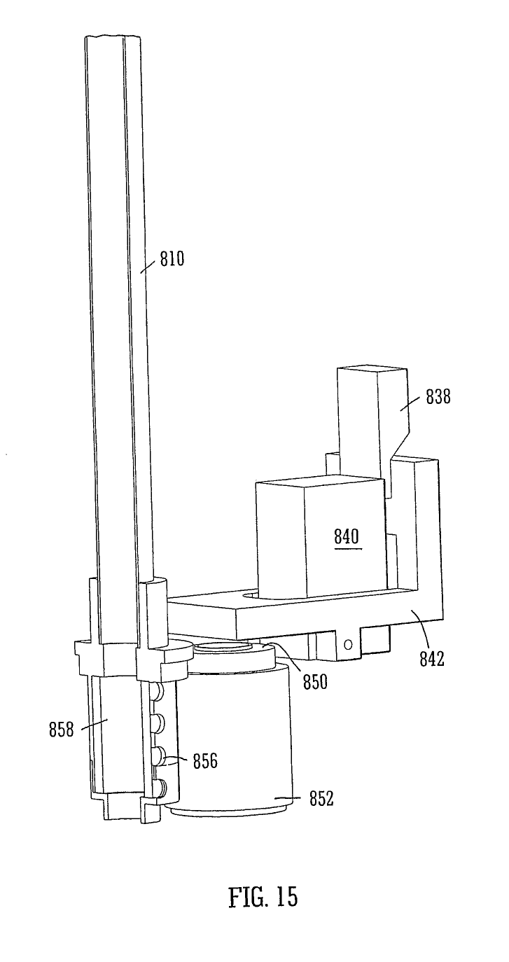

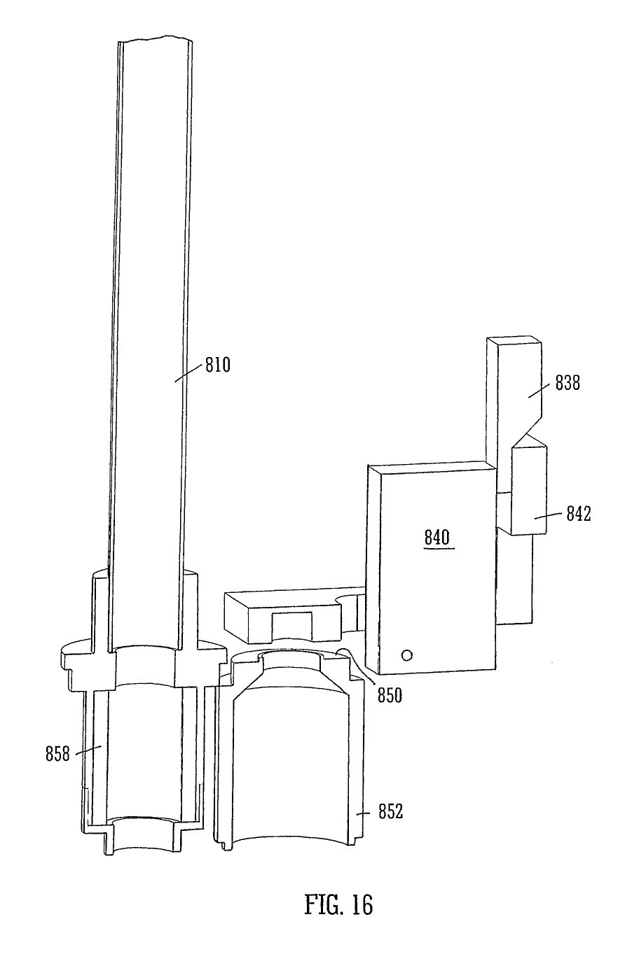

A further possible adaptation is shown with reference to FIGS. 13 to 16. FIGS. 13 and 14 show, again highly schematically, part of a mechanism for altering the amount of water that is heated in the heating chamber. The rest of the apparatus has been omitted for clarity from FIGS. 13 and 14 but this mechanism can be used in any of the previously described arrangements. FIGS. 15 and 16 show in more detail some components of the embodiment of the invention described with reference to FIG. 12 incorporating the mechanism described with reference to FIGS. 13 and 14.

With reference to FIGS. 13 and 14, a broad outline of the water reservoir 802, the heating chamber 804 and the dispensing chamber 812 can be seen. The conduit 810 is shown artificially enlarged for clarity purposes. Unlike in the previous embodiment where the conduit was simply a plain tube projecting down into the heating chamber, in this embodiment the conduit 810 has at its lower end a series of vertically spaced apertures 856. It also has inside it a rotatable inner sleeve 858 which has on it a helically arranged array of apertures 860. It will be immediately apparent therefore that as the sleeve 858 is rotated inside the conduit tube 810, the pair of apertures 856, 860 which are in alignment will change in height. The result of this is that as the heating chamber 804 is filled with water, air can be displaced from the heating chamber through the aligned pair of apertures 856, 860. However, when the water level reaches this aligned pair of apertures, no more air can be displaced, and no more water will enter the heating chamber under gravity. Thus, simply by rotating the sleeve 858 inside the conduit tube 810, e.g. by means of a knob 866, the amount of water which enters the heating chamber can be controlled.

FIGS. 15 and 16 show in more detail some of the components previously described with reference to FIGS. 12, 13 and 14. Thus, on the right hand side of these figures there can be seen the mounting boss 840, the cam member 838 and the L-shaped lever 842. The horizontal wall dividing the reservoir from the liquid heating chamber is omitted, as is the sprung valve seal which is mounted at the end of the horizontal limb of the L-shaped lever 842. However, the valve seat 850 which is foiined as an integral part of the downwardly extending heater chamber inlet tube 852 is shown. To the left of this assembly is the outlet conduit 810, in the lower section of which can be seen the rotatable inner sleeve 858. FIG. 18 shows the apertures 856 in the lower end of the conduit 810, but the helical array of apertures in the sleeve 858 is not visible in either figure.

In this embodiment, depending on the setting of the rotatable sleeve 858, the water level in the heating chamber may not be sufficient to close the buoyant valve initially. However, once the water begins to boil, the increased pressure in the heating chamber closes the buoyant valve and allows the pressure to build further (to promote ejection) and to prevent heated water leaking back into the water reservoir or vice versa.

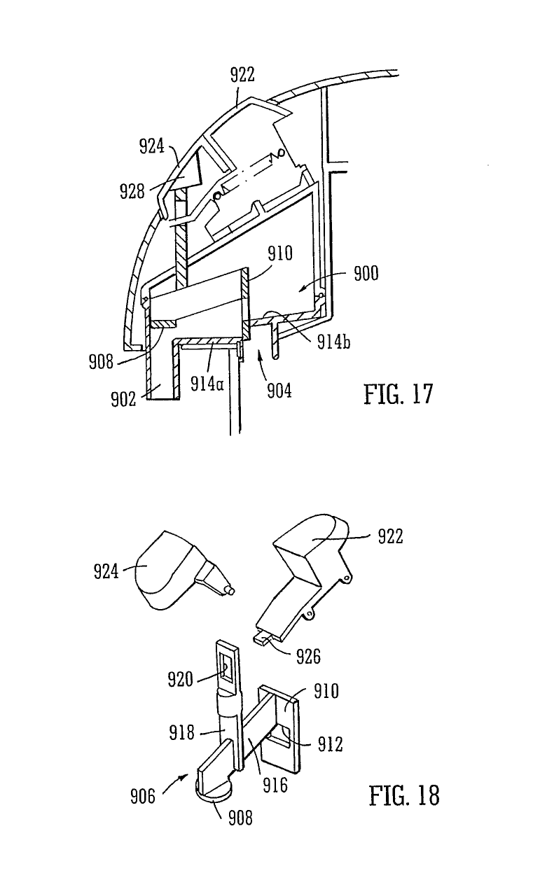

FIGS. 17 and 18 show part of the dispensing chamber of an appliance embodying the invention. In this embodiment, there are two different paths by which heated water in the interior of the dispensing chamber 900 may leave it. The first of these two paths is via the outlet spout 902 which is the default route for the water to take. The alternative outlet route is provided by a drainage outlet 904 which is set back towards the rear of the appliance and which allows water to drain back into the reservoir (not shown) beneath the dispensing chamber. A valve member 906 which is shown most clearly in FIG. 18 allows the water to be diverted through either the spout 902 or the drainage outlet 904 depending upon its vertical position.

The valve member 906 comprises on one side a circular sealing flange 908 which is designed to cap off the upper mouth of the spout tube 902 when the valve member 906 is in its lowermost position. Although not shown, an O-ring or sealing layer may be provided on the underside of the circular flange 908. On the other side of the valve member 906 is a vertical partition 910, with a rectangular aperture 912 defined in it. In use the partition 910 slides vertically within a gap formed between two stepped portions of the base of the dispensing chamber 914a, 914b. The valve member 906 is designed so that when it is in the uppermost position shown in FIG. 17, the circular sealing flange 908 is lifted away from the upper mouth of the spout tube 902 so permitting the flow of water therethrough, whilst the rectangular aperture 912 is misaligned with the vertical gap between the stepped base portions of the chamber 914a, 914b. However, when the valve member 906 is moved to its lower position, the circular flange 908 closes the mouth of the spout tube 902 and the rectangular aperture 912 is aligned with the above-mentioned vertical gap so that water is prevented from flowing out of the spout 902 but can instead flow out of the drainage outlet 904.

An actuating shaft 918 extends vertically from the crossbeam 916 of the valve member and has a vertical rectangular slot 920. The actuating shaft 918 interacts with a dual button arrangement 922, 924 which is used to control operation of the appliance. The rearmost button member 922 is clipped to the trip lever of a steam switch such as the applicant's R48 steam switch (not shown). The button member 922 can therefore be used to close the steam switch and energize the heating element in the heating chamber. It can be seen that this first button member 922 has a small tab 926 on one edge thereof which extends into the rectangular slot 920 of the valve actuation member 918 when installed. The slot 120 allows the first button member 922 to be pressed without moving the valve member 906. The second, foremost button member 924 is pivotally mounted to the first button member 922 and comprises an internal protrusion 928 which engages the top of the valve actuating shaft 918.

Operation of the embodiment of FIGS. 17 and 18 will now be described. FIG. 17 shows the configuration of the various parts prior to operation. When a user desires to use the appliance, he or she depresses the rearmost button 922 which closes the electrical switch contacts of the steam switch (not shown) to energize the heating element in the heating chamber (again not shown). From the perspective of FIG. 17, this will cause the rearmost switch member 922 to pivot in a clockwise direction which causes the tab 926 to move from the bottom of the vertical slot 920 in the valve member actuation shaft 918 to the top of this slot, but does not cause the valve member 906 itself to move.

Water will then be boiled in the heating chamber and ejected through the conduit into the dispensing chamber 900 in the manner previously described. The water is automatically dispensed through the spout 902 until all of the water has been dispensed. However, the user may interrupt dispensing by pressing on the front button 924 (pivoting it anti-clockwise) which presses the valve member 906 to move downwardly. One effect of this downward movement is that the top of the vertical slot 920 presses on the tab 926 to return the first switch member 922 to its original position and thereby switch off the steam switch and de-energize the heating element. Another effect of the downward movement of the valve member 906 is to close off the spout 902 with the horizontal circular flange 908. A third effect of the downward movement is to align the aperture 912 in the vertical partition 910 of the valve member with the vertical gap formed between base member portions 914a, 914b thereby opening a flow path out of the dispensing chamber 900 via the drainage outlet 904 into the reservoir of the appliance (not shown). Thus it can be seen that should a user not wish to dispense all of the water that has been boiled, he or she may simply press the “stop” button 924 which will immediately cease the dispensing option, switch off the appliance and allow the water which has accumulated in the dispensing chamber 900 but which has not yet been dispensed, to be drained safely back into the reservoir. This therefore offers an extremely simple and convenient way of allowing a user to control the amount of heated water that is dispensed.

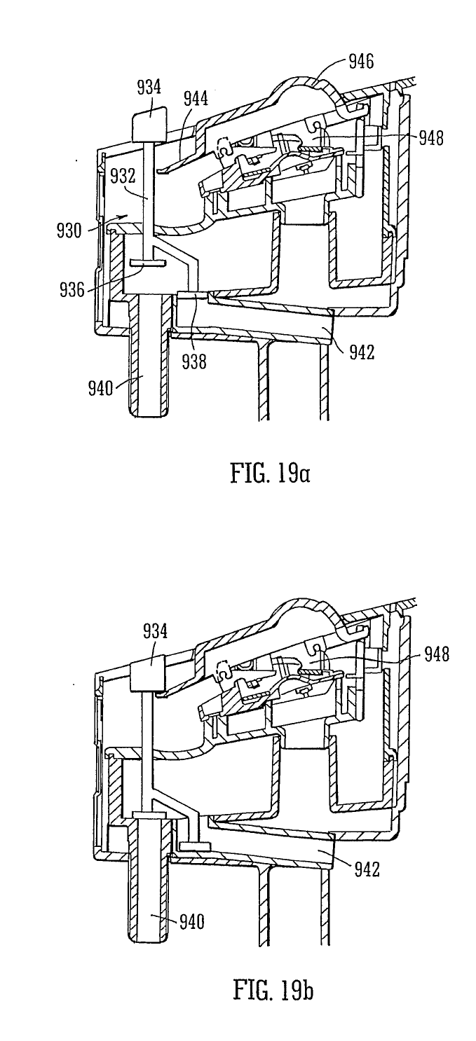

FIGS. 19a and 19b show an alternative embodiment using very similar principles. The common features are not described in detail. In this embodiment the physical arrangement is such that the valve member 930 comprises a vertical shaft 932 which is acted upon by a push button 934 and has a pair of vertically offset horizontal sealing flanges 936, 938 which are able to close respectively the mouths of the spout tube 940 and the drainage outlet tube 942. Although not shown, a bistable spring can provided. This biases the valve member 930 either towards its uppermost position shown in FIG. 19a, which helps to prevent pressure in the dispensing chamber causing the drainage outlet valve to leak; or to its lower position in FIG. 19b to stop dispensing and drain the chamber.

Operation of this embodiment is very similar to that of the previously described embodiment and thus should it be desired by a user to interrupt the automatic dispensing of heated water, he or she may press the stop button 934 to move the valve member 930 down which opens the valve 938 sealing the mouth of the drainage outlet 942 and closes the mouth of the spout tube 940. It will also be seen from FIG. 19b that the lower edge of the button 934 acts on a tab 944 at the distal edge of the rocker switch cover 946 for the steam switch 948. Thus, as in the previous embodiment, pressing the stop button 934 switches off the heater of the appliance.

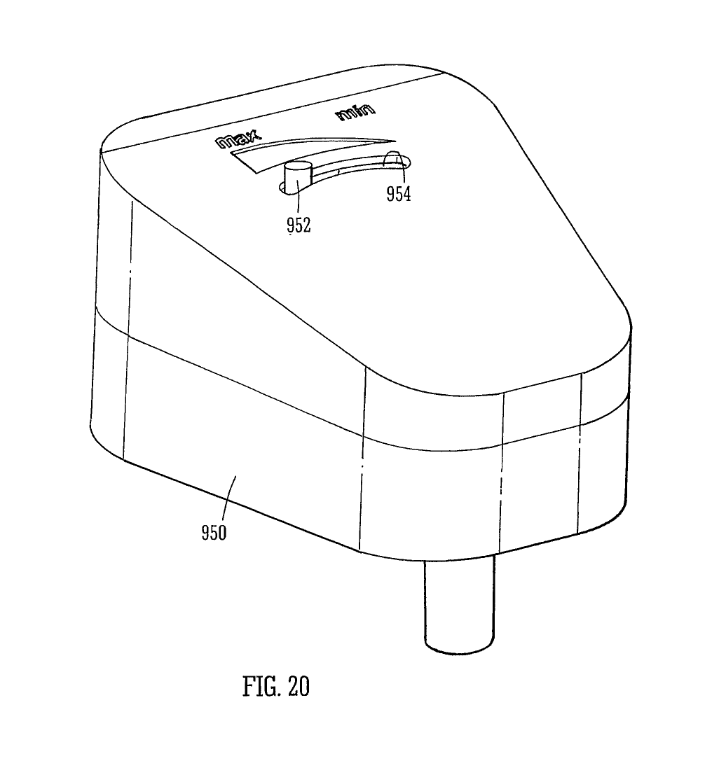

FIGS. 20 to 22 show a further embodiment of the invention in which the amount of water dispensed from the dispensing chamber 950 can be preset. As can be seen from FIG. 20, a user-operable knob 952 is provided which can travel within an arcuate slot 954 to preset a dispense volume between a maximum and minimum value.

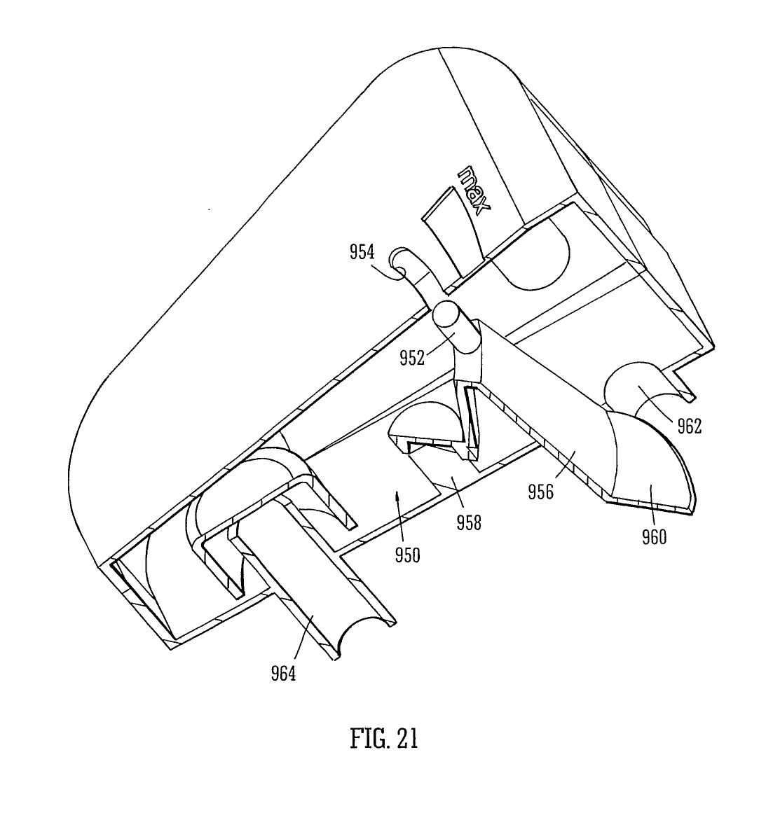

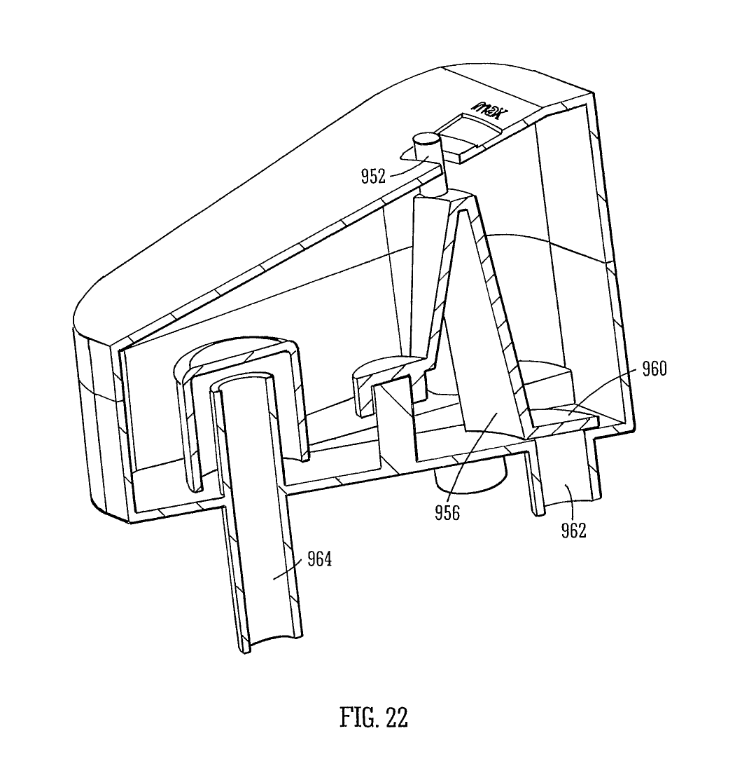

FIGS. 21 and 22 show how this is achieved with FIG. 21 showing the knob 952 at the minimum setting and FIG. 22 showing the knob 952 at the maximum setting.

Inside, the dispensing chamber 950 is similar to that of previously described arrangements, e.g. that of FIG. 5, except that here it may be seen that the control knob 952 is a vertical protrusion from a volume preset member 956 which is mounted for rotation on a boss 958 inside the dispensing chamber. Of course any suitable mechanical arrangement could be used to adjust the position of the volume preset member 956 such as a knob or slider; and any direct actuation or intermediately coupled or geared arrangement is contemplated.

At the distal end of the volume preset member 956 is a generally horizontal, arcuate flange 960 which, depending on how much the member 956 is rotated, can be placed so as to cover a proportion of the area of the mouth of a drainage outlet 962. The arrangement is such that when the knob 952 is at the rightmost end of the slot 954, i.e. at the minimum setting, the flange 960 is completely clear of the outlet 962, whereas at the maximum setting shown in FIG. 22, the flange 960 completely covers the drainage outlet 962.

In operation of this embodiment, water is heated to boiling and ejected from the heating chamber to the dispensing chamber via a conduit which is not visible in FIGS. 21 and 22 and when sufficient water has accumulated in the chamber 950, it starts to flow out from the spout tube 964. However, depending upon the setting of the dispense volume determination member 956, whilst this ordinary dispensing operation is going on, the heated water will also be drained out of the drainage outlet 962. Clearly, the amounts of boiling water which is ultimately dispensed will depend upon the relative rates of flow through the spout 964 and the drainage outlet 962. In the minimum setting shown in FIG. 21, a significant proportion of the water boiled in the heating chamber will go out of the drainage outlet 962 rather than being dispensed through the spout 964. However, as the drainage outlet 962 is increasingly covered by the flange 960 of the volume selection member, more and more of the water will be dispensed through the spout 964 until the situation shown in FIG. 22 where the drainage outlet is completely covered and all of the water will be dispensed through the spout 964. It may be seen therefore that a simple and convenient method is provided whereby a user can preset how much water is dispensed through the spout. It also means that no water will remain in the dispensing chamber 950 at the end of the dispensing operation to have an adverse impact on the water dispensed in the next cycle. As in previous embodiments, the drainage outlet may drain into a special reservoir or the ordinary reservoir.

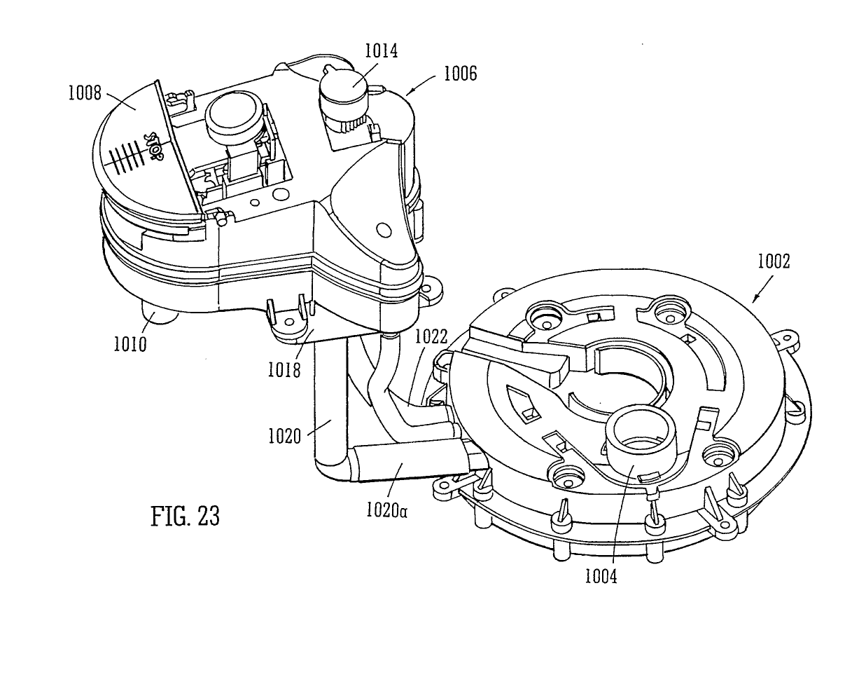

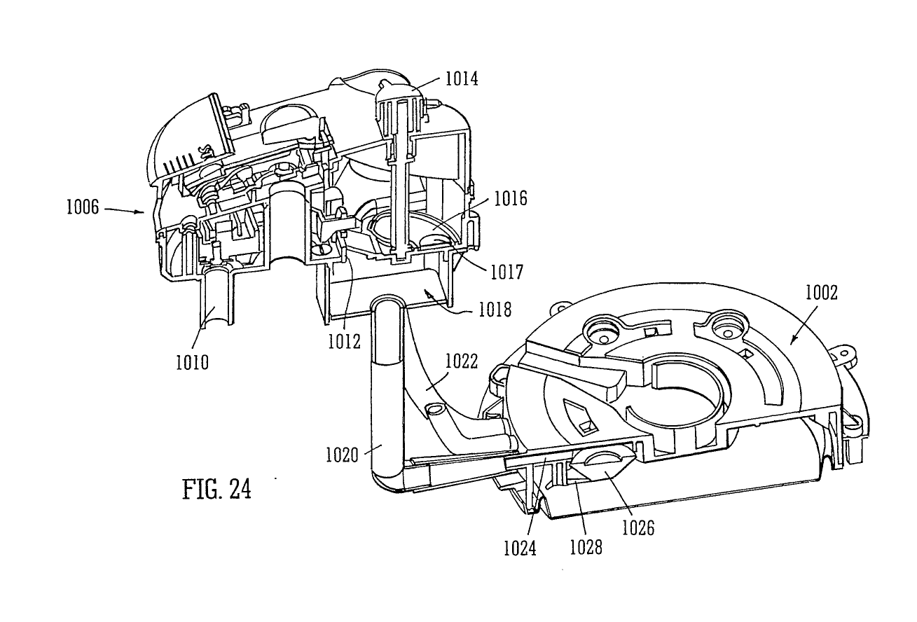

FIGS. 23 and 24 indeed show an embodiment in which the drainage outlet drains into a special reservoir rather than the ordinary reservoir. In this embodiment the water reservoir (not shown) is removable from the heating chamber 1002 and in fact resembles an ordinary kettle. A valve arrangement 1004 is provided to permit water to pass from the reservoir into the heating chamber 1002. This valve arrangement includes a frusto-conical floating valve member of the same type as that described above with reference to FIG. 11.

The dispensing chamber 1006 is similar to previous embodiments. It comprises a “stop” button 1008 which acts to: trip the steam switch and so de-energize the heating element in the heating chamber; close a valve in the main outlet spout 1010; and open a drainage outlet 1012 out of the dispensing chamber 1006. This mechanism is as described with reference to FIGS. 17 and 18. The dispensing chamber also comprises a knob 1014 which can be rotated to rotate a member 1016 that varies the amount of a drain outlet 1017 which is uncovered and so the rate at which water can drain out of the dispensing chamber 1006. This mechanism functions in the same way as that described above with reference to FIGS. 20 to 22.

Below the dispensing chamber 1006 and covering the two drainage outlets 1012 and 1017 therefrom is an auxiliary chamber 1018. A conduit 1020 extends from the bottom of the auxiliary chamber 1018 to an inlet to the heating chamber 1002. As can be seen particularly from FIG. 23, the drainage conduit 1020 and especially its lower portion 1020a are of greater cross-sectional area than the outlet tube 1022 through which water is ejected from the heating chamber 1002 to the dispensing chamber 1006.

Inside the heating chamber 1002 the conduit 1020 is connected to a lateral passage 1024 which is terminated by a valve comprising a floating frusto-conical puck valve member 1026 and retainer 1028 which are the same construction as those shown in the heating chamber of FIG. 11. Clearly being able to use the same components for both valves minimizes the cost.

This embodiment of the invention works in a very similar way to previous arrangements and embodiments. Thus water flows into the heating chamber 1002 through the valve 1004 from the reservoir (not shown) when the latter is installed on the appliance. When the heater is energized water will begin to be heated to boiling in the heating chamber 1002. The corresponding increase in pressure in the heating chamber forces the puck valves 1004, 1026 tightly closed. As the water starts to boil it is ejected via the outlet tube 1022 to the dispensing chamber 1006 where it is dispensed in the normal way. However if the user has set the dispense volume below the maximum using the knob 1014 or presses the stop button 1008 before dispensing has finished, some heated water will drain out from the corresponding drainage outlets 1017, 1012 into the auxiliary chamber 1018 and begin to fill the conduit 1020 connecting it to the heating chamber 1002. However since the valve 1026 still remains sealed at this stage, the conduit 1020 backs up until the chamber 1018 begins to fill up.

Once the heating element has been switched off, the pressure in the heating chamber 1002 reduces as the steam condenses, opening both puck valves 1004, 1026 and sucking in water from the reservoir and the conduit respectively. The relatively large cross-sectional area of the conduit 1020 means that water will flow in more easily from this than from the reservoir. Depending upon the relative dimensions of the inlets and the amounts of water in the reservoir and the conduit/auxiliary chamber respectively the conduit 1020 may be drained completely or some water may remain. However eventually the two puck valves 1004, 1026 will be closed once the heating chamber 1002 has been filled again with water and the appliance is once again ready to be used. Clearly if another dispense cycle is initiated soon thereafter less energy will be required to heat the water than if the cold water from the reservoir had been used exclusively.

It will be appreciated by those skilled in the art that the embodiments described above are only a few examples of the many possible ways in which the invention can be implemented. For example, although the embodiments have been described for producing boiling water, the invention may also be applied to the heating of other liquids e.g. brewed beverages such as tea or coffee or perhaps heated milk for use in beverages. Furthermore, although the embodiments described combine several advantageous features, it is not considered essential for all of these features to be provided together. For example, the siphon outlet arrangement and dispensing chamber may be advantageous even when not used with an arrangement in which steam is passed through water in the dispensing chamber. Similarly the dual action pressure relief valve may have many other possible applications.

The features described in respect of the arrangements shown in FIGS. 1 to 11 can be applied to any embodiments of the invention or can themselves be altered to fall within the scope of the invention—e.g. by adding any of the features described herein in relation to the invention or shown in FIGS. 12 to 24.

What is claimed is:

1. An apparatus for heating liquid comprising a heating chamber, a dispensing chamber and a conduit for conveying heated liquid from said heating chamber to said dispensing chamber for automatic dispensing therefrom, wherein said dispensing chamber comprises a valve through which said heated liquid is dispensed, said valve being operable to interrupt said automatic dispensing.

2. An apparatus as claimed in claim 1 wherein said valve is operable by a user.

3. An apparatus as claimed in claim 1 wherein said valve is coupled to switch contacts for interrupting or reducing the power to a heater for heating said heating chamber.

4. An apparatus as claimed in claim 3 wherein the switch contacts are associated with a steam-sensitive switch.

5. An apparatus as claimed in claim 4 wherein the switch contacts are independently operable to interrupt or reduce power to the heater without interrupting dispensing.

6. An apparatus as claimed claim 1 wherein the dispensing chamber comprises a drainage outlet for draining liquid that has not been dispensed from the dispensing chamber.

7. An apparatus for heating liquid comprising a heating chamber, a dispensing chamber and a conduit for conveying heated liquid from said heating chamber to said dispensing chamber for automatic dispensing therefrom, wherein said dispensing chamber comprises a drainage outlet for draining liquid that has not been dispensed from the dispensing chamber.

8. An apparatus as claimed in claim 6 wherein said drainage outlet is arranged to drain undispensed liquid into a reservoir supplying the heating chamber or back to the heating chamber.

9. An apparatus as claimed in claim 6 wherein said drainage outlet is arranged to drain undispensed liquid into a reservoir supplying the heating chamber or back to the heating chamber.

10. An apparatus for dispensing heated liquid comprising a heating chamber and a dispensing chamber, the apparatus being configured to eject heated liquid from the heating chamber into the dispensing chamber and from there automatically to dispense said heated liquid, wherein the dispensing chamber comprises a drainage outlet arranged to drain undispensed liquid from the dispensing chamber back to the heating chamber.

11. An apparatus as claimed in claim 8 comprising an auxiliary chamber between the dispensing chamber and the heating chamber, the auxiliary chamber being arranged to allow liquid that has drained from the dispensing chamber to collect temporarily in the auxiliary chamber.

12. An apparatus as claimed in claim 6 wherein the drainage outlet comprises a drainage valve.

13. An apparatus as claimed in claim 12 wherein the drainage valve is manually operated.

14. An apparatus as claimed in claim 12 wherein the drainage valve is coupled to a valve controlling the dispensing of liquid from the dispensing chamber.

15. An apparatus as claimed in claim 14 wherein the drainage valve and the valve controlling the dispensing of liquid from the dispensing chamber are provided by a diverter valve arranged to direct liquid flow either to a dispense outlet or to the drainage outlet.

16. An apparatus as claimed in claim 6 wherein said drainage outlet is adapted so as to give a variable drainage flow rate.

17. An apparatus as claimed in claim 1 comprising an arrangement to control the amount of liquid dispensed from the dispensing chamber.

18. An apparatus as claimed in claim 17 comprising an arrangement to control the valve to interrupt dispensing.

19. An apparatus for heating liquid comprising a heating chamber, a dispensing chamber and a conduit for conveying heated liquid from said heating chamber to said dispensing chamber for automatic dispensing therefrom, wherein said apparatus comprises an arrangement means for determining a volume of heated liquid to be dispensed automatically.

20. An apparatus as claimed in claim 19 wherein said arrangement for determining a volume of heated liquid to be dispensed comprises valve through which said heated liquid is dispensed, said valve being operable to interrupt said automatic dispensing.

21. An apparatus as claimed in claim 17 wherein said arrangement for determining a volume of heated liquid to be dispensed is arranged to control the amount of liquid passing through the conduit from the heating chamber to the dispensing chamber.

22. An apparatus as claimed in claim 21 wherein said conduit includes a tube extending down into the heating chamber wherein the height of the end of the tube inside the chamber is variable to vary the amount of liquid left inside the heating chamber after the heated liquid has been ejected.

23-25. (canceled)

26. An apparatus as claimed in claim 1 wherein the heating chamber is configured to heat a body of liquid therein to boiling, and wherein the increase in pressure associated with boiling forces the heated liquid into the conduit and vents it into the dispensing chamber.

27. An apparatus as claimed in claim 7 comprising an arrangement to control the amount of liquid heated in the heating chamber.

28-35. (canceled)

36. An apparatus for heating a measured amount of liquid, said apparatus comprising a heating chamber having an electric heater for heating liquid therein and a dispensing arrangement for dispensing liquid from said heating chamber, wherein said dispensing arrangement includes a manually operable valve for interrupting dispensing of said liquid wherein said valve is coupled to switch contacts for interrupting or reducing power to the electric heater.

37. An apparatus as claimed in claim 36 wherein the switch contacts are associated with a steam-sensitive switch.

38. An apparatus as claimed in claim 37 wherein the switch contacts are independently operable to interrupt or reduce power to the electric heater without interrupting dispensing.

39. An apparatus as claimed in claim 1 comprising a removable liquid reservoir supplying the heating chamber.

40. An apparatus as claimed in claim 9 comprising an auxiliary chamber between the dispensing chamber and the heating chamber, the auxiliary chamber being arranged to allow liquid that has drained from the dispensing chamber to collect temporarily in the auxiliary chamber.

41. An apparatus as claimed in claim 7 wherein the drainage outlet comprises a drainage valve.

42. An apparatus as claimed in claim 41 wherein the drainage valve is manually operated.

43. An apparatus as claimed in claim 41 wherein the drainage valve is coupled to a valve controlling the dispensing of liquid from the dispensing chamber.

44. An apparatus as claimed in claim 43 wherein the drainage valve and the valve controlling the dispensing of liquid from the dispensing chamber are provided by a diverter valve arranged to direct liquid flow either to a dispense outlet or to the drainage outlet.

45. An apparatus as claimed in claim 7 wherein said drainage outlet is adapted so as to give a variable drainage flow rate.

46. An apparatus as claimed in claim 7 comprising an arrangement to control the amount of liquid dispensed from the dispensing chamber.

47. An apparatus as claimed in claim 46 comprising an arrangement to control the valve to interrupt dispensing.

48. An apparatus as claimed in claim 46 wherein said arrangement for determining a volume of heated liquid to be dispensed is arranged to control the amount of liquid passing through the conduit from the heating chamber to the dispensing chamber.

49. An apparatus as claimed in claim 48 wherein said conduit includes a tube extending down into the heating chamber wherein the height of the end of the tube inside the chamber is variable to vary the amount of liquid left inside the heating chamber after the heated liquid has been ejected.

50. An apparatus as claimed in claim 7 wherein the heating chamber is configured to heat a body of liquid therein to boiling, and wherein the increase in pressure associated with boiling forces the heated liquid into the conduit and vents it into the dispensing chamber.

51. An apparatus as claimed in claim 7 comprising a removable liquid reservoir supplying the heating chamber.

52. An apparatus as claimed in claim 10 comprising an auxiliary chamber between the dispensing chamber and the heating chamber, the auxiliary chamber being arranged to allow liquid that has drained from the dispensing chamber to collect temporarily in the auxiliary chamber.

53. An apparatus as claimed in claim 10 wherein the drainage outlet comprises a drainage valve.

54. An apparatus as claimed in claim 10 wherein the drainage valve is manually operated.

55. An apparatus as claimed in claim 10 wherein the drainage valve is coupled to a valve controlling the dispensing of liquid from the dispensing chamber.

56. An apparatus as claimed in claim 55 wherein the drainage valve and the valve controlling the dispensing of liquid from the dispensing chamber are provided by a diverter valve arranged to direct liquid flow either to a dispense outlet or to the drainage outlet.

57. An apparatus as claimed in claim 55 wherein said drainage outlet is adapted so as to give a variable drainage flow rate.

58. An apparatus as claimed in claim 55 comprising an arrangement to control the amount of liquid dispensed from the dispensing chamber.

59. An apparatus as claimed in claim 58 comprising an arrangement to control the valve to interrupt dispensing.

60. An apparatus as claimed in claim 58 wherein said arrangement for determining a volume of heated liquid to be dispensed is arranged to control the amount of liquid passing through the conduit from the heating chamber to the dispensing chamber.

61. An apparatus as claimed in claim 60 wherein said conduit includes a tube extending down into the heating chamber wherein the height of the end of the tube inside the chamber is variable to vary the amount of liquid left inside the heating chamber after the heated liquid has been ejected.

62. An apparatus as claimed in claim 55 wherein the heating chamber is configured to heat a body of liquid therein to boiling, and wherein the increase in pressure associated with boiling forces the heated liquid into the conduit and vents it into the dispensing chamber.

63. An apparatus as claimed in claim 55 comprising an arrangement to control the amount of liquid heated in the heating chamber.

64. An apparatus as claimed in claim 55 comprising a removable liquid reservoir supplying the heating chamber.

65. An apparatus as claimed in claim 19 wherein said arrangement for determining a volume of heated liquid to be dispensed is arranged to control the amount of liquid passing through the conduit from the heating chamber to the dispensing chamber.

66. An apparatus as claimed in claim 65 wherein said conduit includes a tube extending down into the heating chamber wherein the height of the end of the tube inside the chamber is variable to vary the amount of liquid left inside the heating chamber after the heated liquid has been ejected.

67. An apparatus as claimed in claim 19 wherein the heating chamber is configured to heat a body of liquid therein to boiling, and wherein the increase in pressure associated with boiling forces the heated liquid into the conduit and vents it into the dispensing chamber.

68. An apparatus as claimed in claim 19 comprising an arrangement to control the amount of liquid heated in the heating chamber.

69. An apparatus as claimed in claim 19 comprising a removable liquid reservoir supplying the heating chamber.

70. An apparatus as claimed in claim 36 comprising a removable liquid reservoir supplying the heating chamber.
